(19) United States
(12) Patent Application Publication
(10) Pub. No.: US 2017/0153526 A1
(43) Pub. Date: Jun. 1, 2017

(54) REFLECTIVE DISPLAY DEVICE

(71) Applicant: FUJIFILM CORPORATION, Tokyo (JP)

(72) Inventors: Koutaro OKABE, Fujinomiya-shi (JP); Yohei ARITOSHI, Fujinomiya-shi (JP)

(21) Appl. No.: 15/430,552

(22) Filed: Feb. 13, 2017

Related U.S. Application Data
(63) Continuation of application No. PCT/JP2015/073568, filed on Aug. 21, 2015.

(30) Foreign Application Priority Data
Sep. 12, 2014 (JP) 2014-186554

(51) Int. Cl. G02F 1/167; F21V 8/00; G02F 1/1335; G09G 3/34; G09G 3/20

(52) U.S. Cl. CPC G02F 1/167; G09G 3/344; G09G 3/2003; G02F 1/133621; G02B 6/0026; G02F 1/133514; G09G 2380/14; G09G 2320/0242; G09G 2320/0653; G02F 2203/02; G02F 2001/133614; G02F 2001/1672

(57) ABSTRACT

A reflective display device including electrophoresis display unit including an electrophoresis display layer and radiation unit which includes a primary light source that emits light in a previously-specified wavelength range and a light conversion portion including quantum dots that convert the light in a previously-specified wavelength range to white light and radiates the white light to the electrophoresis display layer from a viewer side of electrophoresis display unit.

### CROSS-REFERENCE TO RELATED APPLICATIONS

This application is a continuation application of International Application No. PCT/JP2015/073568, filed Aug. 21, 2015, which is incorporated herein by reference. Further, this application claims priority from Japanese Patent Application No. 2014-186554, filed Sep. 12, 2014, which is incorporated herein by reference.

### BACKGROUND OF THE INVENTION

1. Field of the Invention

The present invention relates to a reflective display device. 2. Description of the Related Art

In response to the distribution of electronic information networks, electronic publishing in which information is displayed on electronic book readers through electronic information networks instead of display media represented by books containing information printed on paper has gradually evolved.

As electronic display devices that display information through electronic information networks, two types (light-emitting type and backlight type) of display devices are known. However, light-emitting type display devices and backlight type display devices cause a huge burden on eyes and are not suitable for applications in which the display devices need to be viewed for a long period of time. Furthermore, since it is necessary to consume a large amount of power in order to emit light or turn backlights on, in a case in which batteries are used as a power supply, information can be displayed only for a limited period of time.

As electronic display devices alternating light-emitting type display devices and backlight type display devices, reflective display devices including electrophoresis display unit including electrophoresis display layers have been proposed.

As typical electrophoresis display layers used in reflective display devices, microcapsule layers in which electrophoresis display elements are arranged on a flat surface in a high density are known. In the electrophoresis display elements, a liquid obtained by dispersing positively or negatively-charged white or black particles in a non-polar transparent dispersion medium is sealed in a microcapsule. As a specific example of electrophoresis display unit (hereinafter, also referred to as “electronic paper”), display panels including a microcapsule layer disposed between a pair of electrodes are known.

Information displayed on electronic paper also, similar to information printed on paper of books, becomes visibly readable due to reflected light and thus only causes as small a burden on eyes as that in books and has an advantage of being capable of alleviating fatigue in eyes compared with light-emitting type display devices and backlight type display devices. Furthermore, electronic paper which becomes readable due to reflected light is still capable of exhibiting display performance in outdoor places under sunlight or illumination light and is thus also suitable for display panels for outdoor boards. Furthermore, in electronic paper, once information is displayed by applying a voltage between a pair of electrodes, the displayed information keeps being displayed even when the voltage is no longer applied between the electrodes, and thus there is an advantage that the power consumption is small and, even in a case in which batteries are used as a power supply, the electronic paper can be operated for a long period of time.

As reflective display devices, in order to compensate for display performance in dark places at which only a small amount of external light such as sunlight arrives, reflective display devices in which radiation unit such as an LED light source is installed have been proposed (refer to JP2013-73127A).

Furthermore, polychromic electronic paper enabling the display of color information also has been proposed. Specifically, color electronic paper and display devices which enable the display of full-color information by disposing a color filter layer including pixels of at least three elementary colors (red, green, and blue) on the surface of electrophoresis display unit have been proposed (for example, refer to JP2013-73127A, JP2003-161964A, JP2010-250992A, and JP2007-171614A).

As methods for forming color filter layers, photolithography methods (for example, refer to Examples 1 to 3 in JP2003-161964A) and inject methods (for example, refer to JP2013-73127A, JP2010-5803895A, and JP2014-71406A) have been disclosed.

### SUMMARY OF THE INVENTION

In electronic paper, basically, external light is used and thus display screens are darker compared with those in two types (light-emitting type and backlight type) of color display devices. Particularly, in color electronic paper, compared with those in two types (light-emitting type and backlight type) of display devices, display screens become darker due to the light absorption of color filters and, particularly, display screens become even darker in places under a small amount of external light such as indoor places. In spite of a huge need for colorization in electronic paper, at the moment, the above-described difficulty in satisfying both the brightness (visibility) and the color reproduction ratio hinders the progress of market extension.

Even color electronic paper in which radiation unit described in JP2013-73127A is installed is not capable of satisfying the visibility and color reproduction ratio of color images and there is a desire for additional improvements.

Therefore, an object of the present invention is to provide a reflective display device having an improved color reproduction ratio of a display screen and excellent visibility.

The present invention achieving the above-described object is as described below:

<1> A reflective display device, comprising: electrophoresis display unit including an electrophoresis display layer; and radiation unit which includes a primary light source that emits light in a previously-specified wavelength range and a light conversion portion including quantum dots that convert the light in a previously-specified wavelength range to white light and radiates the white light to the electrophoresis display layer from a viewer side of the electrophoresis display unit.

<2> The reflective display device according to <1>, in which the radiation unit includes a blue light-emitting diode that emits blue light as a primary light source, and the light conversion portion includes a quantum dot that converts blue light to red light and a quantum dot that converts blue light to green light.

<3> The reflective display device according to <1> or <2>, in which the radiation unit further includes a light guide plate that guides the white light converted in the light conversion portion to a viewer-side surface of the electrophoresis display layer.

<4> The reflective display device according to any one of <1> to <3>, in which the electrophoresis display unit includes a pair of electrodes and a microcapsule layer disposed between the pair of electrodes, the microcapsule layer includes microcapsules including white particles, black particles, and a liquid dispersion medium, one of the white particles and the black particles have a property of being positively charged, and the other particles have a property of being negatively charged.

<5> The reflective display device according to any one of <1> to <4>, further comprising: a color filter layer including pixels of at least three elementary colors (red, green, and blue) between the electrophoresis display unit and the radiation unit.

<6> The reflective display device according to <5>, in which the color filter layer includes pixels formed using an image-forming material, the image-forming material has a photothermal conversion layer and a pixel-forming layer including a colorant and a binder on a support, and pixels are formed using laser light.

<7> The reflective display device according to <5> or <6>, in which the color filter layer includes pixels formed by transferring at least a part of a laser light-irradiated region of an image-forming layer in the image-forming material onto the viewer-side surface of electrophoresis display unit using an image-forming method including forming a laminate by superimposing the image-forming material having the photothermal conversion layer and the pixel-forming layer including the colorant and the binder on the support on the electrophoresis display unit, radiating laser light from an image-forming material side of the laminate in an image shape, and peeling the image-forming material in which the laser light is radiated in the image shape from the electrophoresis display unit.

According to the present invention, a reflective display device having an improved color reproduction ratio of a display screen and excellent visibility is provided.

### BRIEF DESCRIPTION OF THE DRAWINGS

FIG. 1 is a schematic cross-sectional view of a reflective display device according to an embodiment of the present invention.

FIG. 2 is a light source spectrum.

FIG. 3 is an International Commission on Illumination (CIE) chromaticity diagram.

### DESCRIPTION OF THE PREFERRED EMBODIMENTS

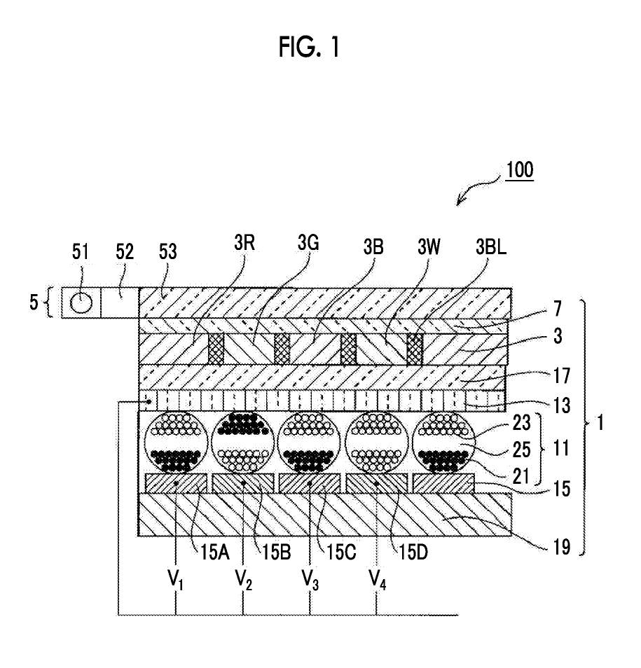

Hereinafter, a reflective display device according to the present invention will be described in detail. In the following description, the present invention will be described on the basis of a typical embodiment of the present invention which is illustrated in FIG. 1 in some cases, but the present invention is not limited to the embodiment illustrated in FIG. 1. Furthermore, in the present specification, ranges expressed as “A to B” include numerical values A and B.

Regarding the expression of groups (atom groups) in the present specification, groups with no expression of ‘substituted’ or ‘unsubstituted’ refer to groups having no substituents and groups having a substituent. For example, “alkyl groups” refer not only to alkyl groups having no substituents (unsubstituted alkyl groups) but also to alkyl groups having a substituent (substituted alkyl groups).

Meanwhile, in the present specification, “(meth)acrylates” represent acrylates and methacrylates, “(meth)acryl” represent acryl and methacryl, and “(meth)acryloyl” represent acryloyl and methacryloyl.

In addition, in the present invention, “% by mass” and “% by weight” have the same meaning, and “parts by mass” and “parts by weight” have the same meaning.

In addition, in the present invention, a combination of preferred embodiments is a more preferred aspect.

A reflective display device according to the present invention has electrophoresis display unit including an electrophoresis display layer and radiation means which includes a primary light source that emits light in a previously-specified wavelength range and a light conversion portion including quantum dots that convert the light in a previously-specified wavelength range to white light and radiates the white light to the electrophoresis display layer from a viewer side of electrophoresis display unit (hereinafter, also referred to as “front light”).

White light in the present invention refers to, with respect to pure color light such as blue light, red light, and green light, light obtained by mixing these pure color light rays so as to continuously include light rays having a variety of wavelengths and thus have a wavelength width.

FIG. 1 is a schematic cross-sectional view of a reflective display device according to a particularly preferred embodiment of the present invention.

In FIG. 1, electrophoresis display unit 1 has a microcapsule layer 11 in which microcapsules including black particles 21, white particles 23, and a liquid dispersion medium 25 are arranged on a flat surface and a pair of electrodes 13 and 15 disposed so as to sandwich the microcapsule layer 11. One electrode 13 is formed as a continuous layer on one surface (the bottom surface in FIG. 1) of a transparent substrate 17. The other pixel electrode 15 is formed by arranging a plurality of electrodes in a two-dimensional manner on one surface (the top surface in FIG. 1) of a rear surface substrate 19 as illustrated as pixel electrodes 15A, 15B, 15C, and 15D in FIG. 1. The pixel electrodes 15A, 15B, 15C, and 15D are respectively connected to voltage application unit Vᵢ, V₂, V₃, and V₄.

Out of the black particles 21 and the white particles 23 in the microcapsule, one of the particles have a property of being positively charged, and the other of the particles have a property of being negatively charged. Therefore, when a voltage applied to the electrode 13 or between the electrode 13 and the pixel electrode is controlled for every pixel electrode unit, for the black particles 21 and the white particles 23 in the microcapsules, it is possible to move the black particles 21 in the microcapsule toward the electrode 13 and move the white particles 23 toward the pixel electrode or vice versa in each of the microcapsules depending on the voltage applied to every pixel electrode unit. For example, as illustrated in FIG. 1, in the microcapsules on the pixel electrodes 15A and 15C, the white particles 23 move toward the transparent electrode 13, and the black particles 21 move toward the pixel electrodes 15A and 15C.

Therefore, it is possible to display white images in the microcapsule layer 11 in electrophoresis display unit 1. That is, it is possible to observe white images from a side of the microcapsule layer 11 on which the transparent electrode 13 is disposed, which is a viewer-side surface of electrophoresis display unit 1.

As the microcapsules in the microcapsule layer 11, it is preferable to include microcapsules containing only white particles or only black particles or both microcapsules containing only white particles and microcapsules containing only black particles. Therefore, it becomes easy to reproduce images having a broad density range from a low reflection to a high reflection density and a broad tone. In FIG. 1, the microcapsule on the pixel electrode 15D is a microcapsule containing only white particles.

The microcapsule only containing white particles may contain only white particles having a property of being positively charged or only white particles having a property of being negatively charged or may contain both as the white particles. What has been described above shall also apply to microcapsules containing only black particles.

In order to display color images on electrophoresis display unit 1, a color filter layer 3 including pixels 3R, 3G and 3B of at least three elementary colors (red (R), green (G), and blue (B)) is provided on the viewer-side surface of electrophoresis display unit 1, that is, the surface of the transparent substrate 17 (the top surface of the transparent substrate 17 in FIG. 1). Between individual pixels in the color filter layer, black matrixes 3BL may be provided.

Furthermore, the color filter layer 3 preferably includes, in addition to the pixels of three elementary colors, a transparent pixel 3W capable of displaying black or white. In such a case, it is possible to display color images having an extended reflection density range and excellent color reproducibility.

In the reflective display device according to the present invention, electrophoresis display unit 1 or colorization electrophoresis display unit further having a color filter layer is provided with radiation unit which will be described below and is also called a front light. That is, a front light 5 which includes a primary light source that emits light in a previously-specified wavelength range and a light conversion portion including quantum dots that convert the light in a previously-specified wavelength range to white light and radiates the white light to the electrophoresis display layer from the viewer side of electrophoresis display unit.

The disposition location, the shape, and the like of the front light 5 are not limited as long as the front light is capable of radiating white light to the microcapsule layer 11 from the viewer side of electrophoresis display unit 1. For example, a constitution in which the primary light source and the light conversion portion including a quantum dot that converts light emitted from the primary light source to white light are disposed on one side of a frame formed around the circumference of rectangular electrophoresis display unit 1 may be provided, or a constitution in which the primary light sources and the light conversion portions including a quantum dot that converts light emitted from the primary light source to white light are disposed on two facing sides may be provided.

In a case in which the reflective display device according to the present invention has electrophoresis display unit having a rectangular shape when seen from the viewer side, in the particularly preferred embodiment, a primary light source 51 and a light conversion portion 52 are installed on one side of electrophoresis display unit 1 as in the reflective display device 100 illustrated in FIG. 1. It is preferable to provide a structure in which light emitted from the primary light source 51 is turned into white in the light conversion portion 52 and the white light is guided to the surface of the transparent substrate 17 through a light guide plate 53.

Hereinafter, the primary light source 51 and the light conversion portion 52 in the front light 5 will be described in detail.

<Primary Light Source in Front Light>

The primary light source 51 in the front light according to the present invention is a light source that emits light in a previously-specified wavelength range. A blue light-emitting diode (hereinafter, also referred to as “blue LED”) emitting blue light is preferably used as the primary light source since the blue light-emitting diode is a light source having a small power consumption amount and high luminance.

Blue light-emitting diodes are commercially available, and a commercially available product may be used.

As the primary light source, in addition to the blue LED, a light-emitting diode such as an ultraviolet ray-emitting diode, a red light-emitting diode, or a green light-emitting diode may be used.

Light-emitting diodes have a huge advantage since the power consumption is low, the size is small, and the cost is low.

The blue LED is also advantageous since it is possible to reduce the types of quantum dots included in the light conversion portion. Blue light emitted from the blue light-emitting diode is converted to white light in the light conversion portion including quantum dots.

<Light Conversion Portion>

The light conversion portion that converts blue light to white light preferably includes a quantum dot R that converts some of blue light to red light and a quantum dot G that converts some of blue light to green light. Due to red light converted from red light in the light conversion portion, green light converted from green light in the light conversion portion, and blue light of which the wavelength is not converted in the light conversion portion (that is, blue light that has passed through the light conversion portion unchanged), blue light emitted from the blue light-emitting diode is converted to white light.

In the light conversion portion 52, light in a previously-specified wavelength range which has been emitted from the primary light source 51 is converted to white light. For example, in a case in which a blue LED is used as the primary light source, the light conversion portion preferably includes a quantum dot R that absorbs some of blue light and emits red light and a quantum dot G that absorbs some of blue light emitted from the blue LED and emits green light. The light conversion portion may include an inorganic fluorescent body as necessary instead of the quantum dots.

The quantum dot refers to a semiconductor nanoparticle having a quantum confinement effect.

The particle diameter of the quantum dot (semiconductor nanoparticle) is generally in a range of 1 nm to 10 nm.

When absorbing light from an excited source and reaching an energy-excited state, the quantum dot emits energy corresponding to the energy band gap of the quantum dot. Therefore, when the size of the quantum dot or the composition of a substance is adjusted, it is possible to adjust the energy band gap and obtain energies having wavelength bands in a variety of levels.

For example, in a case in which the particle diameter of the quantum dot is 5.5 nm to 10 nm, red light is emitted, in a case in which the particle diameter of the quantum dot is 2.5 nm to 5 nm, green light is emitted, and, in a case in which the particle diameter of the quantum dot is 1 nm to 2 nm, blue light is emitted. The quantum dot emitting yellow light has a middle size between the quantum dot emitting red and the quantum dot emitting green.

However, the particle diameter may somewhat fluctuate.

Here, the quantum dot emitting red light is the above-described quantum dot R, the quantum dot emitting green light is the above-described quantum dot and the quantum dot emitting blue light is the above-described quantum dot B.

Due to the quantum size effect, it is possible to easily obtain light rays having a variety of colors such as red light, green light, and blue light from the above-described quantum dots. Therefore, it is also possible to produce light rays that emit at individual wavelengths and generate and realize white or a variety of colors by mixing red light, green light, and blue light.

For example, in a case in which light emitted from the primary light source is blue light, the light conversion portion preferably includes the quantum dot R and the quantum dot G.

The quantum dot R converts some of blue light to red light having a wavelength of 620 nm to 750 nm (preferably 600 nm to 670 nm), and the quantum dot G converts some of blue light to green light having a wavelength of 495 nm to 570 nm. In addition, blue light that is not converted to red light and green light passes through the light conversion portion unchanged.

Therefore, blue light, red light, and green light is emitted from the light conversion portion, and these light rays are mixed together so as to generate white light.

Meanwhile, in a case in which light emitted from the primary light source is red light, the light conversion portion may include the quantum dot B and the quantum dot and, in a case in which light emitted from the primary light source is green light, the light conversion portion may include the quantum dot B and the quantum dot R.

In addition, in a case in which light emitted from the primary light source is monochromatic light other than blue light, red light, and green light, a violet ray, or an infrared ray, all of the light conversion portion, the quantum dot R, the quantum dot and the quantum dot B may be included, and light that has passed through the light conversion portion may be filtered to blue light, red light, and green light.

However, from the viewpoint of the light conversion efficiency, an aspect in which the primary light source is blue light and the light conversion portion includes the quantum dot R and the quantum dot G is most preferred.

The quantum dot is preferably a semiconductor nanoparticle including at least one compound selected from the group consisting of II-VI Group compounds, III-V Group compounds, IV-VI Group compounds, and IV Group compounds.

The quantum dot is more preferably at least one semiconductor nanoparticle selected from the following compound group.

—Compound group—

CdSe, CdTe, ZnS, ZnSe, ZnTe, ZnO, HgS, HgSe, HgTe, CdSeS, CdSeTe, CdSTE, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTE, CdHgSeS, CdHgSeTe, CdHgSTe, HgZnSeS, HgZnSeTe, HgZnSTe (all are “II-VI Group compounds”), GaN, GaP, GaAs, GaSb, AlN, AlP, AlAs, AlSb, InN, InP, InAs, InSb, GaNP, GaNAs, GaNSb, GaPAs, GaPSb, AlNP, AINAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb (all are “III-V Group compounds”), SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, SnPbSTe (all are “IV-VI Group compounds”), Si, Ge, SiC, SiGe (all are “IV Group compounds”).

The quantum dot can be synthesized using a chemical wet method.
The chemical wet method is a method in which a precursor substance is put into an organic solvent and particles are grown.

In addition, the quantum dot may be provided with a core •shell structure.

On the surface of the semiconductor nanoparticle as the quantum dot, an organic ligand may be present.

Examples of the organic ligand include pyridine, mercapto alcohols, thiols, phosphine, phosphinic oxides, and the like, and the organic ligand plays a role of stabilizing the quantum dot that is unstable after being synthesized.

The light conversion portion may include other inorganic fluorescent bodies in addition to the quantum dots (at least the quantum dot G).

Examples of the other inorganic fluorescent bodies include yttrium aluminum garnet (YAG)-based fluorescent bodies, terbium aluminum garnet (TAG)-based fluorescent bodies, sialon-based fluorescent bodies, barium orthosilicate (BOS)-based fluorescent bodies, and the like.

The light conversion portion may include a resin.

A preferred aspect of the light conversion portion is an aspect in which the quantum dots are dispersed in a resin.

As the resin, a substance that does not absorb primary light is preferably used.

As the resin, more specifically, at least one resin selected from the group consisting of epoxy-based resins, silicone-based resins, acrylic resins, and carbonate-based high molecules is preferably used.

In a case in which the resin is elastic, it is also possible to improve the durability of the display device against external impacts.

In addition, the light conversion portion may include glass in addition to the resin.

Specific aspects of the light conversion portion include light conversion members obtained by storing a resin in which the quantum dots (and the other inorganic fluorescent bodies as necessary) are dispersed in a light-transmissive container such as a glass case, light conversion films made of a resin in which the quantum dots (and the other inorganic fluorescent bodies as necessary) are dispersed, light conversion layers including a resin in which the quantum dots (and the other inorganic fluorescent bodies as necessary) are dispersed, light conversion sheets including a light-transmissive protective film that coats both surfaces of a light conversion layer, and the like.

Examples of a method for forming the above-described light conversion portion include a method in which the resin in which the quantum dots (and the other inorganic fluorescent bodies as necessary) are dispersed is formed using a well-known forming method, a method in which a coating fluid including the resin in which the quantum dots (and the other inorganic fluorescent bodies as necessary) are dispersed and an organic solvent is applied and dried on a support (the above-described protective film or the like), and the like.

In addition, it is also possible to use, for example, a Quantum-Dot enhancement Film (QDEF) which is a commercially available product of nanosys, Inc. Furthermore, it is also possible to use a glass tube “Color IQ” (registered trademark) emitting light that has been turned into white by quantum dots which is a commercially available product of QD Vison Inc. as a member including a light conversion portion including a primary light source that emits light in a previously-specified wavelength range and quantum dots that convert light in a previously-specified wavelength range into white light in the front light according to the present invention.

In the reflective display device of the present invention, as illustrated in FIG. 1, it is preferable that light in a previously-specified wavelength range which is emitted from the primary light source 51 is turned into white in the light conversion portion 52 and the white light is guided to the surface of the transparent substrate 17 through the light guide plate 53, thereby displaying images.

<Light Guide Plate>

The light guide plate 53 is, for example, a film of a transparent resin such as a polycarbonate resin, an acrylic resin, or a polyethylene terephthalate resin, the top and bottom surfaces of the film are used as reflective surfaces, and white light is repeatedly reflected in the film. Some of white light that is repeatedly reflected in the film is emitted toward electrophoresis display unit 1 in the middle, and the electrophoresis display layer is illuminated by the emitted white light. Therefore, the shapes of the top and bottom surfaces of the film forming the light guide plate 53 are preferably controlled so that white light is repeatedly reflected in the film and some of the white light is emitted toward electrophoresis display unit 1 in the reflection process. As the shape of the surface of the light guide plate 53 opposite to electrophoresis display unit 1 (the top surface of the light guide plate 53 in FIG. 1), for example, a saw teeth shape as described in Paragraph “0034” of JP2013-73127A is provided.

Furthermore, for example, the light guide plate described in JP4739327B is also a preferred example.

As illustrated in FIG. 1, the light guide plate 53 is preferably adhered to electrophoresis display unit 1 through an adhesive layer 7. The light guide plate 53 and the adhesive layer 7 are preferably combined together so that the refractive index difference reaches 0.2 or less since it is possible to alleviate the reflection of white light at the interface between the light guide plate 53 and the adhesive layer 7.

<Electrophoresis Display Unit>

A preferred aspect of electrophoresis display unit in the reflective display device of the present invention includes a pair of electrodes and a microcapsule layer which is disposed between the electrodes and functions as the electrophoresis display layer. The microcapsule layer is a layer formed by arranging a plurality of microcapsules (electrophoresis display elements) including white particles, black particles, and a liquid dispersion medium respectively in a two-dimensional manner. Out of the black particles and the white particles in the microcapsules, one of the particles have a property of being positively charged, and the other of the particles have a property of being negatively charged.

In the reflective display device 100 illustrated in FIG. 1, electrophoresis display unit 1 includes the microcapsule layer 11 in which microcapsules including a dispersion liquid in which the black particles 21 and the white particles 23 are dispersed in the liquid dispersion medium 25 are arranged on a flat surface and a pair of the electrodes 13 and 15 disposed so as to sandwich the microcapsule layer 11. One electrode 13 is transparent and is formed as a continuous layer on one surface (the bottom surface in FIG. 1) of the transparent substrate 17. The other pixel electrode 15 is formed by arranging a plurality of pixel electrodes in a two-dimensional manner on one surface (the top surface in FIG. 1) of the rear surface substrate 19 as illustrated as the pixel electrodes 15A, 15B, 15C, and 15D in FIG. 1.

For the electrode 13, it is possible to use, in addition to light-transmissive highly conductive metallic materials such as indium titanium oxide (ITO) and indium zinc oxide (IZO), metal nanowires having excellent conductivity such as a silver nanowire, carbon nanotubes, thiophene-based compounds, and the like. In the formation of the electrode 13, it is possible to use techniques of the related art such as dry film-forming methods such as a deposition method, a sputtering method, and a chemical vapor deposition (CVD) method and wet film-forming methods in which a coating fluid is used. In a case in which the electrode 13 is formed using a dry film-forming method, the transparent substrate 17 is preferably a glass substrate having excellent heat resistance.

Between the electrode 13 and the transparent substrate 17, a undercoat layer, not illustrated, may be provided. In a case in which the refractive index of the undercoat layer is an intermediate refractive index between the refractive index of the electrode 13 and the refractive index of the transparent substrate 17, the reflection of light at the interface between the electrode 13 and the transparent substrate 17 is alleviated, and thus it becomes possible to display images having superior visibility.

The undercoat layer is preferably a layer including a resin such as a urethane resin, an acrylic resin, a polyester resin, or a vinyl chloride resin. In order to adjust the refractive index of the undercoat layer, it is possible to add a refractive index adjuster to the undercoat layer. Specific examples of the refractive index adjuster include, for example, zirconium oxide, titanium oxide, and the like.

The pixel electrode 15 which serves as the counter electrode of the electrode 13 may be, similar to the electrode 13, made of a light-transmissive poorly conductive metallic material in addition to a light-transmissive highly conductive metallic material such as indium titanium oxide (ITO) or indium zinc oxide (IZO). Examples thereof include metals such as aluminum, silver, and molybdenum.

The pixel electrode 15 is formed by arranging a plurality of electrodes in a two-dimensional manner on one surface (the top surface in FIG. 1) of the rear surface substrate 19 as illustrated as pixel electrodes 15A, 15B, 15C, and 15D in FIG. 1.

As the rear surface substrate 19, in addition to a glass plate, a substrate made of a resin such as polyvinyl chloride, polyester, or polyethylene terephthalate, a natural resin, or the like, or a combination thereof is used, and the shape thereof is not particularly limited.

In the microcapsules in the microcapsule layer 11, the white particles 23 and the black particles 21 are sealed in the microcapsule shell in a state of being dispersed in the liquid dispersion medium 25. Out of the white particles 23 and the black particles 21 in the microcapsules, one of the particles have a property of being positively charged, and the other of the particles have a property of being negatively charged. That is, the microcapsule layer 11 functioning as the electrophoresis display layer includes microcapsules in which positively-charged electrophoresis particles of a first color and negatively-charged electrophoresis particles of a second color are included in a liquid dispersion medium.

The average particle diameter in the microcapsules is preferably in a range of 20 μm to 60 μm, and the particles can be purified using an arbitrary method such as sieving or a specific weight separation method.

As the black particles 21, it is possible to use, in addition to an inorganic pigment such as inorganic carbon, fine powder of glass or a resin, complexes thereof, and the like. As the white particles 23, it is possible to use, well-known white inorganic pigments such as titanium oxide, silica, alumina, and zinc oxide, organic compounds such as a vinyl acetate emulsion, and furthermore, complexes thereof and the like.

Meanwhile, for the white particles 23 and the black particles 21, as necessary, desired surface charges can be imparted by treating the surfaces of the particles using a variety of surfactants, dispersants, organic and inorganic compounds, metals, and the like, and furthermore, the dispersion stability can be improved by preventing agglomeration caused by the electrostatic force and the like between different types of particles in the liquid dispersion medium 25.

As the liquid dispersion medium 25, it is possible to use a solvent made of aliphatic hydrocarbon, aromatic hydrocarbon, alicyclic hydrocarbon, a variety of esters, alcohols, or other resins or a combination thereof. A solution including the white particles 23, the black particles 21, and the liquid dispersion medium 25 is sealed in a microcapsule using a well-known method such as a phase separation method such as mixing coacervation, an interface polymerization method, or an in-situ method. Examples of the material of the capsule shell include gum Arabic, methacrylate resins, urea resins, and the like.

The microcapsules are dispersed in a dispersion liquid including water as the main component, and a binder resin made of a dielectric resin such as a urethane resin, an acrylic resin, a polypropylene resin, a phenolic resin, or polylactic acid is injected into the dispersion liquid, thereby preparing a microcapsule coating fluid. A preferred range of the proportion of the solid content mass in the total mass in the coating fluid is approximately 20% by mass to 60% by mass in a broad sense since the proportion also depends on the application method of the coating fluid. The binder resin can be used singly or in a mixture form.

The microcapsule layer 11 may be formed by applying the microcapsule coating fluid onto the surface of the transparent electrode 13 provided on the transparent substrate 17 or may be formed by applying the microcapsule coating fluid onto the surface of the pixel electrode 15 provided on the rear surface substrate 19.

As a method for applying the microcapsule coating fluid, it is possible to employ a variety of methods such as die coating, bar coating, microgravure coating, or screen printing.

The thickness of the microcapsule layer 11 needs to be at least as thick as the microcapsule. The microcapsule is flexible and thus may be deformed in a flat columnar shape. The thickness of the microcapsule layer 11 is generally selected from a range of 30 μm to 60 μm.

The microcapsule layer 11 includes a number of microcapsules, and, when a voltage is applied in order to control the orientation of an electric field between the electrode 13 and the pixel electrode 15, the black particles 21 and the white particles 23 in the microcapsules are moved, whereby images can be displayed.

The black particles 21 and the white particles 23 in the microcapsules in the microcapsule layer 11 are dispersed in the liquid dispersion medium 25, and a viscous liquid can be used as the liquid dispersion medium 25. In a case in which the liquid dispersion medium 25 is viscous, once a voltage is applied to the microcapsules, the locations of the black particles 21 and the white particles 23 do not change even when the voltage is no longer applied. Therefore, the display device has a memory capability and thus displayed images do not disappear. As a result, a voltage needs to be applied only when information is rewritten, and it is possible to display images and operate the display device for a long period of time without exchanging primary batteries or charging secondary batteries regardless of the types of a power supply (primary batteries and secondary batteries).

<Color Filter Layer>

The reflective display device according to the present invention includes a color filter layer and is thus capable of enabling the color display of full colors.

As illustrated in FIG. 1, the color filter layer 3 includes pixels 3R, 3G, and 3B of at least three (red, green, and blue)-elementary colors. The color filter layer 3 preferably further includes a colorless transparent pixel 3W since color reproducibility can be obtained in a broad range from a low density to a high density. A black partition wall 3BL called a black matrix may be provided around each of the pixels.

The respective color pixels and the transparent pixel in the color filter layer 3 can be produced using a well-known method such as a photolithography method or an ink jet method.

In the reflective display device according to the present invention, a color filter including pixels formed using a laser thermal transfer method is preferably provided since it becomes possible to display bright full-color images having a broad color reproduction range.

An image-forming material that is used in the laser thermal transfer method preferably has a photothermal conversion layer and a pixel-forming layer including a colorant and an acrylic resin on a support.

In the reflective display device according to the present invention, the reason for the combination of the front light according to the present invention and a color filter formed using the laser thermal transfer method enabling the display of bright full-color images is not clear, but is assumed as described below.

In the color filter formed using the laser thermal transfer method, the density of the colorant included in images constituting the respective pixels is high. In a case in which a color filter having a high density of the colorant is provided, images having excellent color sharpness can be obtained, but there are cases in which images become dark. However, a front light including a quantum dot-whitening LED light source has high luminance, and thus images can be recognized as bright images, and consequently, an effect of the NTSC color reproduction range (a color gamut produced by the National Television System Committee of USA) being large and thus bright images being displayed can be obtained.

<Image-Forming Material>

Hereinafter, the image-forming material that is used in the laser thermal transfer method will be described in detail.

The image-forming material that is used in the laser thermal transfer method has a photothermal conversion layer and a pixel-forming layer including a colorant and an acrylic resin on a support.

(Support)

The material of the support in the image-forming material is not particularly limited, and a variety of support materials can be used in accordance with the purposes. The support preferably has stiffness, favorable dimensional stability, and resistance to heat during the formation of images. Preferred examples of the support material include synthetic resin materials such as polyethylene terephthalate, polyethylene-2,6-naphthalate, polycarbonate, polymethyl (meth)acrylate, polyethylene, polypropylene, polyvinyl chloride, polyvinylidene chloride, polystyrene, styrene-acrilonitrile copolymers, (aromatic or aliphatic) polyamide, polyimide, polyamideimide, polysulfone, and polyether sulfone. Among these, biaxially-stretched polyethylene terephthalate or polyether sulfone is preferred in consideration of the mechanical strength and the dimensional stability against heat.

Furthermore, since laser recording is used, the support in the image-forming material is preferably formed of a transparent synthetic resin material that transmits laser light.

The thickness of the support is preferably selected from a range of 25 μm or more and 130 μm or less and particularly preferably 50 μm or more and 120 μm or less.

The central line average surface roughness Ra (measured on the basis of JIS B0601 (2001) using a surface roughness measurement instrument (Surfcom, manufactured by Tokyo Seimitsu Co., Ltd.) or the like) of the support on a side on which the image-forming layer is provided is preferably less than 0.1 μm.

The Young's Modulus of the support in the longitudinal direction is preferably 200 kg/mm² or more and 1,200 kg/mm² or less (that is, 2 GPa to 12 GPa), and the Young's Modulus in the width direction is preferably 250 kg/mm² or more and 1,600 kg/mm² or less (that is, 2.5 GPa to 16 GPa).

The F-5 value of the support in the longitudinal direction (a value obtained by dividing the load value when a test specimen is extended 5% by the cross-sectional area of the test specimen) is preferably 5 kg/mm² or more and 50 kg/mm² or less (that is, 49 MPa to 490 MPa), the F-5 value of the support in the width direction is preferably 3 kg/mm² or more and 30 kg/mm² or less (that is, 29.4 MPa to 294 MPa), and, generally, the F-5 value of the support in the longitudinal direction is higher than the F-5 value of the support in the width direction, which may not be true in a case in which it is necessary to increase particularly the strength in the width direction.

The thermal shrinkage percentage of the support in the longitudinal direction and the width direction at 100° C. for 30 minutes is preferably 3% or less and more preferably 1.5% or less and the thermal shrinkage percentage at 80° C. for 30 minutes is preferably 1% or less and more preferably 0.5% or less.

The rupture strength in both directions is preferably 5 kg/mm² or more and 100 kg/mm² or less (that is, 49 MPa to 980 MPa), and the elastic modulus is preferably 100 kg/mm² or more and 2,000 kg/mm² or less (that is, 0.98 GPa to 19.6 GPa).

In order to improve the adhesiveness to a photothermal conversion layer provided on the support, the surface of the support may be subjected to a surface activation treatment and/or may be provided with one or more undercoat layers.

Examples of the surface activation treatment include a glow discharge treatment, a corona discharge treatment, and the like.

The material of the undercoat layer is preferably a material which exhibits strong adhesiveness to both surfaces of the support and the photothermal conversion layer, is poorly thermal-conductive, and has excellent heat resistance. Examples of a material of the undercoat layer as described above include styrene, styrene-butadiene copolymers, gelatin, and the like. The entire thickness of the undercoat layer is generally 0.01 μm or more and 2 μm or less.

The rear surface of the support, as necessary, may be provided with an anti-reflection layer, an antistatic layer, and back layers having a variety of functions such as blocking prevention or may be subjected to a surface treatment.

(Back Layer)

In a case in which the back layer is provided with an antistatic function, it is preferable to add conductive fine particles of at least one oxide selected from SnO₂, ZnO, Al₂O₃, TiO₂, In₂O₃, MgO, BaO, and MoO₃ to the back layer. The average particle diameter of the conductive fine particles is generally in a range of 0.001 μm or more and 0.5 μm or less and preferably in a range of 0.003 μm or more and 0.2 μm or less. The average particle diameter mentioned herein refers to a value including not only the primary particle diameter of a conductive metallic oxide but also the particle diameter of a high-order structure.

To the back layer, it is possible to add, in addition to the antistatic agent, a variety of additives such as a surfactant, a lubricant, and a matting agent or a binder.

Examples of the binder that is used for the formation of the back layer include homopolymers and copolymers of an acrylic acid-based monomer such as acrylic acid, methacrylic acid, acrylic acid ester, or methacrylic acid ester, cellulose-based polymers such as nitrocellulose, methyl cellulose, ethyl cellulose, and cellulose acetate, polyethylene, polypropylene, polystyrene, vinyl chloride-based copolymers, vinyl chloride-vinyl acetate copolymers, copolymers of vinyl-based polymers and vinyl compounds such as polyvinylpyrrolidone, polyvinyl butyral, and polyvinyl alcohols, condensed polymers such as polyester, polyurethane, and polyamide, rubber-based thermoplastic polymers such as butadiene-styrene copolymers, polymers obtained by polymerizing and crosslinking a photopolymerizable or heat-polymerizable compound such as an epoxy compound, melamine compounds, and the like.

(Photothermal Conversion Layer)

The photothermal conversion layer includes a photothermal conversion substance, preferably includes a binder, and includes a matting agent as necessary. The photothermal conversion layer further includes other components as necessary.

The photothermal conversion substance is a substance having a function of converting light energy being radiated to heat energy. Generally, the photothermal conversion substance is a dye (including a pigment, which also shall apply below) capable of absorbing laser light. In a case in which images are recorded using an infrared laser, an infrared-absorbing dye is preferably used as the photothermal conversion substance. Examples of the dye include black pigments such as carbon black, pigments of a macrocyclic compound absorbing light in a visible light to near-infrared range such as phthalocyanine and naphthalocyanine, organic dyes that is used as a laser-absorbing material for high-density laser recording such as optical disc (cyanine dyes such as indolenine dyes, anthraquinone-based dyes, azulene-based dyes, and phthalocyanine-based dyes), and organic metallic compound dyes of a dithiol nickel complex or the like. Among these, cyanine-based dyes exhibit a high absorbance index with respect to light in the infrared range and thus, when being used as the photothermal conversion substance, are capable of reducing the thickness of the photothermal conversion layer, and consequently, the recording sensitivity of the image-forming material can be further improved, which is preferable. As the photothermal conversion substance, it is also possible to use, in addition to the dyes, inorganic materials such as particulate metallic materials such as blackened silver.

The binder that is added to the photothermal conversion layer is preferably a resin having at least a strength great enough to form layers on the support and high thermal conductivity. Furthermore, when a resin which has heat resistance and is thus not decomposed by heat generated from the photothermal conversion substance is used during the recording of images, the flatness of the surface of the photothermal conversion layer can be maintained after light radiation even when high-energy light is radiated, which is preferable. Specifically, a resin having a decomposition temperature (a temperature at which the mass decreases by 5% in an air stream at a temperature increase rate of 10° C./minute in a thermogravimetric analysis (TGA)) of 400° C. or higher is preferred, and a resin having a decomposition temperature of 500° C. or higher is more preferred.

In addition, the binder preferably has a glass transition temperature of 200° C. or higher and 400° C. or lower and more preferably has a glass transition temperature of 250° C. or higher and 350° C. or lower. When the glass transition temperature is lower than 200° C., there are cases in which fogging is caused in images being formed, and, when the glass transition temperature is higher than 400° C., the solubility of resins degrades, and there are cases in which the production efficiency decreases. Furthermore, the heat resistance (for example, the heat distortion temperature or the decomposition temperature) of the binder in the photothermal conversion layer is preferably stronger than those of materials that are used for other layers provided on the photothermal conversion layer. Specific examples thereof include acrylic resins such as polymethyl (meth)acrylate, polycarbonate, polystyrene, vinyl chloride/vinyl acetate copolymers, vinyl-based resins such as polyvinyl alcohols, polyvinyl butyral, polyester, polyvinyl chloride, polyamide, polyimide, polyetherimide, polysulfone, polyether sulfone, aramid, polyurethane, epoxy resins, urea/melamine resins, and the like. Among these, polyimide resins are preferred.

Particularly, polyimide resins represented by General Formulae (I) to (VII) below are soluble in organic solvents, and, when these polyimide resins are used, the productivity of the image-forming material improves, which is preferable. In addition, the polyimide resins are also preferable since the viscosity stability, long-term storage stability, and moisture resistance of coating fluids for the photothermal conversion layer improve.

Here, regarding an index for determining whether or not a resin is soluble in an organic solvent, a solubility of the resin of 10 parts by mass or more in 100 parts by mass of N-methylpyrrolidone at 25° C. is set as the standard, and, in a case in which 10 parts by mass or more of the resin is dissolved, the resin is preferably used as the resin for the photothermal conversion layer. A resin having a solubility of 100 parts by mass or more in 100 parts by mass of N-methylpyrrolidone is more preferred.

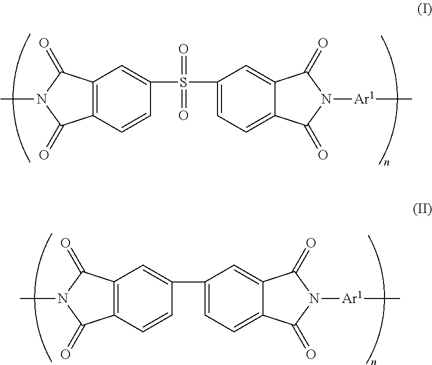

In General Formulae (I) and (II), Ar¹ represents an aromatic group represented by Structural Formula (1), (2), or (3), and n represents an integer of 10 or higher and 100 or lower.

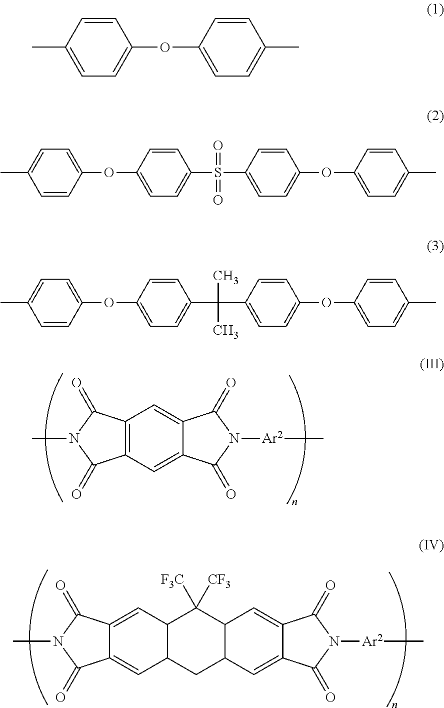

In General Formulae (III) and (IV), Ar² represents an aromatic group represented by Structural Formula (4) to (7), and n represents an integer of 10 or higher and 100 or lower.

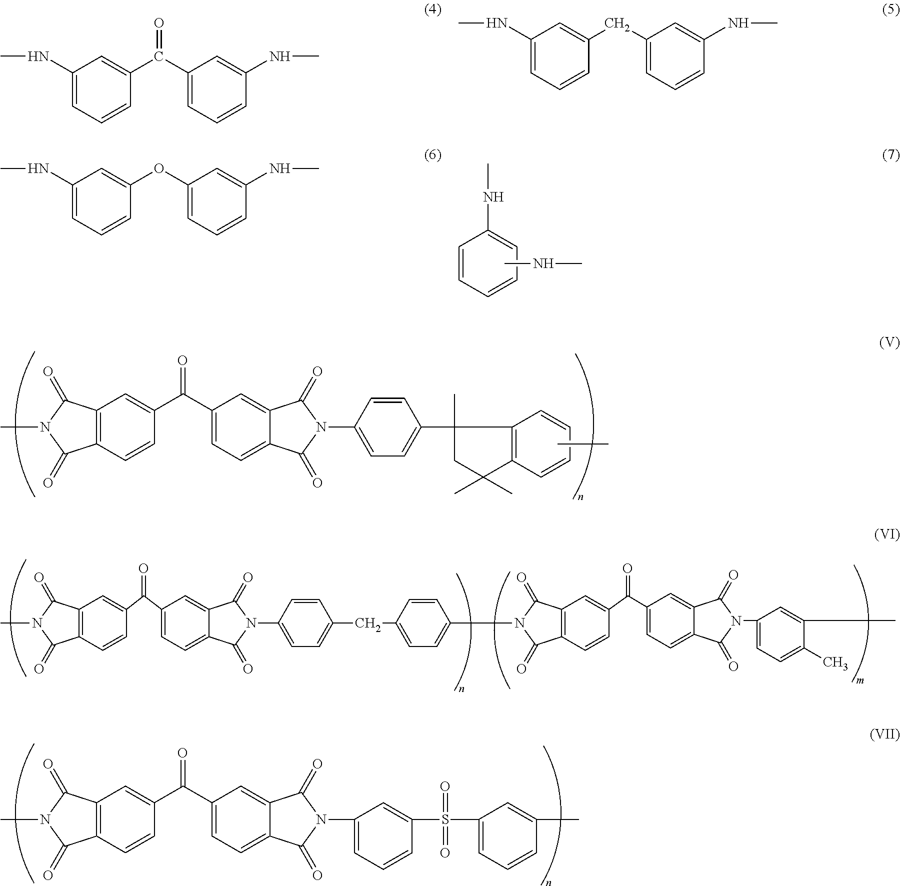

In General Formulae (V) to (VII), n and m each independently represent an integer of 10 or higher and 100 or lower. In Formula (VI), the ratio between n and m is 6:4 to 9:1.

Examples of the matting agent in the photothermal conversion layer include inorganic fine particles and organic fine particles. Examples of the inorganic fine particles include metal salts such as silica, titanium oxide, aluminum oxide, zinc oxide, magnesium oxide, barium sulfate, magnesium sulfate, aluminum hydroxide, magnesium hydroxide, and boron nitride, kaolin, clay, talc, Chinese white, flake white, zeeklite, quartz, diatomaceous earth, pearlite, bentonite, mica, synthetic mica, and the like. Examples of the organic fine particles include resin particles such as fluororesin particles, guanamine resin particles, acrylic resin particles, styrene-acryl copolymer resin particles, silicone resin particles, melamine resin particles, and epoxy resin particles. The number-average particle diameter of the matting agent is generally 0.3 μm or more and 30 μm or less and preferably 0.5 μm or more and 20 μm or less. The amount of the matting agent in the back layer is preferably in a range of 0.1 mg/m² or more and 100 mg/m² or less.

To the photothermal conversion layer, a surfactant, a viscosity improver, an antistatic agent, and the like may be further added as necessary.

The photothermal conversion layer can be provided by preparing a coating fluid in which the photothermal conversion substance and the binder are dissolved and the matting agent and other components are added thereto as necessary and applying and drying the coating fluid on the support. Examples of an organic solvent used to dissolve the polyimide resin include n-hexane, cyclohexane, diglyme, xylene, toluene, ethyl acetate, tetrahydrofuran, methyl ethyl ketone, acetone, cyclohexanone, 1,4-dioxane, 1,3-dioxane, dimethyl acetate, N-methyl-2-pyrrolidone, dimethyl sulfoxide, dimethylformamide, dimethylacetamide, γ-butyrolactone, ethanol, methanol, and the like. The coating and the drying can be carried out using an ordinary coating method and an ordinary drying method. The drying is generally carried out at a temperature of 300° C. or lower and preferably carried out at a temperature of 200° C. or lower. In a case in which polyethylene terephthalate is used for the support, the support is preferably dried at a temperature of 80° C. or higher and 150° C. or lower.

When the amount of the binder in the photothermal conversion layer is too small, the cohesive force of the photothermal conversion layer decreases, the photothermal conversion layer is likely to be transferred together with formed images when the formed images are transferred to an image-receiving sheet, and color mixing in images is caused. In addition, when the amount of the binder is too great, the layer thickness of the photothermal conversion layer increases in order to achieve a certain light absorbance, and thus sensitivity degradation is likely to be caused. The solid content amount ratio between the photothermal conversion substance and the binder in the photothermal conversion layer is preferably 1:20 or more and 2:1 or less and, particularly, more preferably 1:10 or more and 2:1 or less.

When the thickness of the photothermal conversion layer is reduced, the sensitivity of the image-forming material can be increased, which is preferable. Therefore, the thickness of the photothermal conversion layer is preferably 0.03 μm or more and 1.0 μm or less and more preferably 0.05 μm or more and 0.5 μm or less.

In the photothermal conversion layer, the laser light-absorbing wavelength is preferably in a range of 700 nm or more and 1,500 nm or less and particularly in a range of 750 nm or more and 1,000 nm or less. Furthermore, when the photothermal conversion layer preferably has an optical density of 0.7 to 1.1 with respect to light having a wavelength of 830 nm and more preferably has an optical density of 0.8 to 1.0 with respect to light having a wavelength of 830 nm since the transfer sensitivity of the image-forming layer improves. When the optical density at a wavelength of 830 nm is less than 0.7, the capability of converting radiated light to heat becomes weak, and there are cases in which the transfer sensitivity degrades. When the optical density at a wavelength of 830 nm exceeds 1.1, the functions of the photothermal conversion layer are affected during recording, and there are cases in which fogging occurs.

(Image-Forming Layer)

The image-forming layer includes a colorant and a binder.

[Pigment]

The colorant in the image-forming layer is preferably a pigment having excellent heat resistance.

Pigments are generally classified into organic pigments and inorganic pigments. Organic pigments provide, particularly, excellent transparency to coated films, and inorganic pigments generally have a characteristic of excellent concealment, and thus pigments may be appropriately selected depending on the applications.

As the organic pigments, organic pigments matching the respective colors (red, green, and blue) of the RGB three elementary colors or having a close hue are preferably used.

There are cases in which, other than the organic pigments, metal powder, fluorescent pigments, and the like are used.

Examples of pigments that are preferably used include azo-based pigments, phthalocyanine-based pigments, anthraquinone-based pigments, dioxazine-based pigments, quinacridone-based pigments, isoindolinone-based pigments, and nitro-based pigments. Pigments that are used for the image-forming layer will be classified according to the color tones and listed below, but are not limited thereto.

1) Yellow Pigments

C.I. Pigment Yellow 1, C.I. Pigment Yellow 3, C.I. Pigment Yellow 12, C.I. Pigment Yellow 13, C.I. Pigment Yellow 14, C.I. Pigment Yellow 15, C.I. Pigment Yellow 16, C.I. Pigment Yellow 17, C.I. Pigment Yellow 20, C.I. Pigment Yellow 24, C.I. Pigment Yellow 31, C.I. Pigment Yellow 55, C.I. Pigment Yellow 60, C.I. Pigment Yellow 61, C.I. Pigment Yellow 65, C.I. Pigment Yellow 71, C.I. Pigment Yellow 73, C.I. Pigment Yellow 74, C.I. Pigment Yellow 81, C.I. Pigment Yellow 83, C.I. Pigment Yellow 93, C.I. Pigment Yellow 95, C.I. Pigment Yellow 97, C.I. Pigment Yellow 98, C.I. Pigment Yellow 100, C.I. Pigment Yellow 101, C.I. Pigment Yellow 104, C.I. Pigment Yellow 106, C.I. Pigment Yellow 108, C.I. Pigment Yellow 109, C.I. Pigment Yellow 110, C.I. Pigment Yellow 113, C.I. Pigment Yellow 114, C.I. Pigment Yellow 116, C.I. Pigment Yellow 117, C.I. Pigment Yellow 119, C.I. Pigment Yellow 120, C.I. Pigment Yellow 126, C.I. Pigment Yellow 127, C.I. Pigment Yellow 128, C.I. Pigment Yellow 129, C.I. Pigment Yellow 138, C.I. Pigment Yellow 139, C.I. Pigment Yellow 150, C.I. Pigment Yellow 151, C.I. Pigment Yellow 152, C.I. Pigment Yellow 153, C.I. Pigment Yellow 154, C.I. Pigment Yellow 155, C.I. Pigment Yellow 156, C.I. Pigment Yellow 166, C.I. Pigment Yellow 168, C.I. Pigment Yellow 175, C.I. Pigment Yellow 180, C.I. Pigment Yellow 185, and the like.

2) Magenta Pigments

C.I. Pigment Red 48:1, C.I. Pigment Red 48:2, C.I. Pigment Red 48:3, C.I. Pigment Red 53:1, C.I. Pigment Red 57:1, C.I. Pigment Red 122, C.I. Pigment Red 177, and the like.

3) Cyan Pigments

C.I. Pigment Blue 15, C.I. Pigment Blue 15: 1, C.I. Pigment Blue 15: 2, C.I. Pigment Blue 15: 3, C.I. Pigment Blue 15: 4, C.I. Pigment Blue 15: 6, C.I. Pigment Blue 60, and the like.

4) Red Pigments

C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48:1, C.I. Pigment Red 48:2, C.I. Pigment Red 48:3, C.I. Pigment Red 48:4, C.I. Pigment Red 49:1, C.I. Pigment Red 49:2, C.I. Pigment Red 50:1, C.I. Pigment Red 52:1, C.I. Pigment Red 53:1, C.I. Pigment Red 57, C.I. Pigment Red 57:1, C.I. Pigment Red 57:2, C.I. Pigment Red 58:2, C.I. Pigment Red 58:4, C.I. Pigment Red 60:1, C.I. Pigment Red 63:1, C.I. Pigment Red 63: 2, C.I. Pigment Red 64:1, C.I. Pigment Red 81:1, C.I. Pigment Red 83, C.I. Pigment Red 88, C.I. Pigment Red 90:1, C.I. Pigment Red 97, C.I. Pigment Red 101,

C.I. Pigment Red 102, C.I. Pigment Red 104, C.I. Pigment Red 105, C.I. Pigment 106, C.I. Pigment Red 108, C.I. Pigment Red 112, C.I. Pigment Red 113, C.I. Pigment Red 114, C.I Pigment Red 122, C.I. Pigment Red 123, C.I. Pigment Red 144, C.I. Pigment Red 146, C.I. Pigment Red 149, C.I. Pigment Red 150, C.I. Pigment Red 151, C.I. Pigment Red 166, C.I. Pigment Red 168, C.I. Pigment Red 170, C.I. Pigment Red 171, C.I. Pigment Red 172, C.I. Pigment Red 174, C.I. Pigment Red 175, C.I. Pigment Red 176, C.I. Pigment Red 177, C.I. Pigment Red 178, C.I. Pigment Red 179, C.I. Pigment Red 180, C.I. Pigment Red 185, C.I. Pigment Red 187, C.I. Pigment Red 188, C.I. Pigment 190, C.I. Pigment Red 193, C.I. Pigment Red 194, C.I. Pigment Red 202, C.I. Pigment Red 206, C.I. Pigment Red 207, C.I. Pigment Red 208, C.I. Pigment Red 209, C.I. Pigment Red 215, C.I. Pigment Red 216, C.I. Pigment Red 220, C.I. Pigment Red 224, C.I. Pigment Red 226, C.I. Pigment Red 242, C.I. Pigment Red 243, C.I. Pigment Red 245, C.I. Pigment Red 254, C.I. Pigment Red 255, C.I. Pigment Red 264, C.I. Pigment Red 265, and the like.

5) Green Pigments

C.I. Pigment Green 7, C.I. Pigment Green 36, C.I. Pigment Green 58, and the like. 6) Blue Pigments

C.I. Pigment Blue 15, C.I. Pigment Blue 15:3, C.I. Pigment Blue 15:4, C.I. Pigment Blue 15:6, C.I. Pigment Blue 60, and the like.

7) Violet Pigments

C.I. Pigment Violet 23 and the like.

Particularly, in a case in which the respective pixels of red, green, and blue in the color filter are formed, the following combinations are preferred. The reason therefor is not clear, but is considered that the adsorption state between components other than the pigments used in the image-forming layer, particularly, a pigment dispersant, a surface modifier, and a binder and the following pigments is optimal, and the combinations are excellent in terms of the dispersibility of the pigments and contribute to the high resolution of pixels by the improvement in the brightness of transferred images and the improvement in the adhesiveness to transfer subjects being transferred.

[Red] At least one pigment selected from C.I. Pigment Red 254, C.I. Pigment Red 177, C.I. Pigment Yellow 138, and C.I. Pigment Yellow 150 is included. Particularly preferred specific examples thereof include a combination of C.I. Pigment Red 254 and C.I. Pigment Yellow 138 and a combination of C.I. Pigment Red 177 and C.I. Pigment Yellow 150.

[Green] At least one pigment selected from C.I. Pigment Green 36, C.I. Pigment Green 58, C.I. Pigment Yellow 138, and C.I. Pigment Yellow 150 is included. Particularly preferred specific examples thereof include a combination of C.I. Pigment Green 58 and C.I. Pigment Yellow 138.

[Blue] At least one pigment selected from C.I. Pigment Blue 15:6 and C.I. Pigment Violet 23 is included. Particularly preferred specific examples thereof include a combination of C.I. Pigment Blue 15:6 and C.I. Pigment Violet 23.

First, it is desirable to prepare a dispersion liquid of the pigments. The dispersion liquid can be prepared by adding and dispersing a composition obtained by previously mixing the pigments and a pigment dispersant in an organic solvent (or a vehicle) described below. The vehicle refers to a solvent portion that disperses the pigments when the composition is in a liquid state and includes a portion which is in a liquid state and bonds to the pigments so as to stabilizer dispersion (a dispersant or a dispersion aid) and a component which dissolves and dilutes the above-described portion (an organic solvent). A disperser used to disperse the pigments is not particularly limited and can be appropriately selected depending on the purposes, and examples thereof include well-known disperses such as a kneader, a roll mill, an attritor, a super mill, a dissolver, a homomixer, and a sand mill which are described in “Pigment Dictionary”, Vol. 1, Asakura Publishing Co., Ltd., 2000, p. 438. Furthermore, the pigments may be finely ground using a friction force by unit of the mechanical grinding described in “Pigment Dictionary”, p. 310.

The number-average particle diameter of the pigments is adjusted to be in a range of 30 nm or more and 100 nm or less. The reason therefor is as described above. Particularly, the number-average particle diameter of the pigments is preferably 50 nm or more and 80 nm or less.

In the present invention, the “particle diameter” refers to a diameter of a circle having the same area as that of a cross-section of each pigment particle in a case in which a cross-section of the image-forming material is cut out using a microtome and the cross-section of the image-forming layer is observed using an electronic microscope. In the present invention, the “number-average particle diameter” is defined as the average value of the particle diameters of 100 particles that are randomly selected from a number of particles the particle diameters of which are obtained.

In the present invention, the content of the pigments is preferably in a range of 20 parts by mass or more and 60 parts by mass or less and more preferably in a range of 25 parts by mass or more and 55 parts by mass or less with respect to 100 parts by mass of the total solid content of the image-forming layer.

[Binder]

The binder in the image-forming layer according to the present invention is preferably a resin having a weight-average molecular weight of 20,000 or more and 60,000 or less and particularly preferably a resin having a weight-average molecular weight of 30,000 or more and 50,000 or less. When the weight-average molecular weight of the resin is 20,000 or more, it is possible to increase the intensity of formed images, and when the weight-average molecular weight of the resin is 60,000 or less, the edge sharpness of the pixels is improved, and it becomes easy to achieve a high resolution.

The weight-average molecular weight is measured by unit of gel permeation chromatography (GPC). Specifically, HLC-8120GPC and SC-8020 (manufactured by Tosoh Corporation) were used, two TSKgel SuperHM-H (manufactured by Tosoh Corporation, 6.0 mmID×15 cm) were used as columns, and tetrahydrofuran (THF) was used as an eluent. In addition, as the conditions, the specimen concentration is set to 0.5% by mass, the flow rate is set to 0.6 ml/min, the sample injection amount is set to 10 μl, and the measurement temperature is set to 40° C., and an RI detector is used. Calibration curves are produced from ten samples of “polystyrene standard specimen TSK standard” manufactured by Tosoh Corporation: “A-500”, “F-1”, “F-10”, “F-80”, “F-380”, “A-2500”, “F-4”, “F-40”, “F-128”, and “F-700”.

The resin having a weight-average molecular weight of 20,000 or more and 60,000 or less is preferably a copolymer of polymerizable monomers including at least at least one monomer of selected from at least acrylic acid and methacrylic acid and two monomers of benzyl (meth)acrylate (hereinafter, also referred to as “benzyl(meth)acrylate copolymer”) and a copolymer of polymerizable monomers including at least at least one monomer of selected from acrylic acid and methacrylic acid and two monomers of styrene (hereinafter, also referred to as “styrene copolymer”).

The benzyl(meth)acrylate copolymer may include a repeating unit derived from a polymerizable monomer other than three monomers of acrylic acid, methacrylic acid, and benzyl (meth)acrylate. Similarly, the styrene copolymer may include a repeating unit derived from a polymerizable monomer other than three monomers of acrylic acid, methacrylic acid, and styrene.

In the benzyl(meth)acrylate copolymer, in a case in which the total amount of the repeating units in the benzyl(meth)acrylate copolymer is set to 100 mol %, the proportion of the repeating unit derived from at least one monomer selected from acrylic acid and methacrylic acid is preferably in a range of 10 mol % or more and 40 mol % or less and more preferably in a range of 20 mol % or more and 30 mol % or less. Similarly, the proportion of the repeating unit derived from benzyl (meth)acrylate is preferably in a range of 20 mol % or more and 80 mol % or less and more preferably in a range of 30 mol % or more and 80 mol % or less.

In the styrene copolymer, in a case in which the total amount of the repeating units in the styrene copolymer is set to 100 mol %, the proportion of the repeating unit derived from at least one monomer selected from acrylic acid and methacrylic acid is preferably in a range of 10 mol % or more and 40 mol % or less and more preferably in a range of 20 mol % or more and 30 mol % or less. Similarly, the proportion of the repeating unit derived from styrene is preferably in a range of 20 mol % or more and 80 mol % or less and more preferably in a range of 30 mol % or more and 80 mol % or less.

Examples of other polymerizable monomer forming the repeating unit derived from other polymerizable monomer which may be included in the benzyl(meth)acrylate copolymer or the styrene copolymer include the following monomers.

Examples of other polymerizable monomer include methacrylic acid esters such as methyl methacrylate, ethyl methacrylate, butyl methacrylate, and hydroxyethyl methacrylate; acrylic acid esters such as methyl acrylate, ethyl acrylate, butyl acrylate, and 2-ethylhexyl acrylate; acrylic acid, maleic acid, maleic acid esters, maleic anhydride, itaconic acid, crotonic acid, and the like. Among these, methyl methacrylate is particularly preferred.

The proportion of the repeating unit derived from other monomers in the copolymer is appropriately selected from a range of 0 mol % or more and 60 mol % or less.

The content of the binder in the image-forming layer is preferably 1 part by mass or more and 40 parts by mass or less with respect to 100 parts by mass of the total solid content in the image-forming layer. The content of the copolymer is particularly preferably 2 parts by mass or more and 35 parts by mass or less since transferred images having superior contrast and resolution can be obtained.

The image-forming layer may include, as a binder, a resin other than two copolymers of the benzyl (meth)acrylate copolymer and the styrene copolymer (hereinafter, also referred to as “additional resin”).

The additional resin is preferably an amorphous organic high-molecular-weight polymer having a softening point of 40° C. or higher and 150° C. or lower. Examples of the above-described amorphous organic high-molecular-weight polymer include butyral resins, polyamide resins, polyethylene imine resins, sulfonamide resins, polyester polyol resins, petroleum resins, and the like. Furthermore, examples thereof include homopolymers and copolymers of styrene such as styrene, vinyl toluene, a-methylstyrene, 2-methylstyrene, chlorostyrene, vinyl benzoate, sodium vinyl benzene sulfonate, or aminostyrene, a derivative, or a substitution product thereof; methacrylic acid esters and methacrylic acid such as methyl methacrylate, ethyl methacrylate, butyl methacrylate, and hydroxyethyl methacrylate, acrylic acid esters and acrylic acid such as methyl acrylate, ethyl acrylate, butyl acrylate, a-ethylhexyl acrylate, dienes such as butadiene and isoprene, acrylonitrile, vinyl ethers, maleic acid, maleic acid esters, maleic anhydrides, cinnamic acid, vinyl-based monomer such as vinyl chloride and vinyl acetate or copolymers of a vinyl-based monomer and another monomer (which may be a monomer for forming the binder for the present invention), and the like. These resins can be used singly or two or more resins can be used in a mixture form, and the content of the resin being used is preferably in a range of 40 parts by mass or less with respect to 100 parts by mass of the total solid content of the image-forming layer.

The image-forming layer includes a plasticizer, which is preferable since an advantage of the easy formation of images having excellent edge sharpness can be obtained.

[Plasticizer]

The plasticizer that is used in the image-forming layer according to the present invention is not particularly limited and can be appropriately selected depending on the purposes.

When the melting point or the softening point of the plasticizer is in a range of 50° C. to 150° C., the resolution of images improves, which is preferable. Meanwhile, the softening point can be obtained using the Vicat method (specifically, a polymer softening point measurement method according to ASTM D1235).

The above-described plasticizer is particularly preferably selected from the group consisting of 1) monomers and oligomers having at least two ethylenic unsaturated double bonds, 2) acrylic resins having a weight-average molecular weight of 10,000 or less, 3) butyral resins, 4) rosin resins, and 5) wax.

Hereinafter, these compounds will be described in detail.

(1) Monomers and oligomers having at least two ethylenic unsaturated double bonds

Monomers and oligomers in the present invention are monomers and oligomers having two or more ethylenic unsaturated double bonds. The above-described monomers and oligomers are compounds having at least two ethylenic unsaturated groups, which are capable of addition polymerization, in the molecule and a boiling point of 100° C. or higher at normal temperature.

Examples thereof include polyethylene glycol di(meth)acrylate, polypropylene glycol di(meth)acrylate, trimethylolethane triacrylate, trimethylolpropane tri(meth)acrylate, trimethylol propane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylolpropane tri(acryloyloxypropyl) ether, tri(acryloyloxyethyl) isocyanurate, tri(acryloyloxyethyl) cyanurate, glycerin tri(meth)acrylate; polyfunctional acrylates or polyfunctional methacrylates obtained by adding ethylene oxide or propylene oxide to a polyfunctional alcohol such as trimethylolpropane or glycerin and then forming a (meth)acrylate.

Furthermore, examples thereof include polyfunctional acrylates or methacrylates of urethane acrylates described in JP1973-41708B (JP-S48-41708B), JP1975-6034B (JP-S50-6034B), JP1976-37193A (JP-S51-37193A); polyester acrylates described in JP1973-64183A (JP-S48-64183A), JP1974-43191B (JP-S49-43191B), JP1977-30490B (JP-S52-30490B); and epoxy acrylates which are reaction products between an epoxy resin and (meth)acrylic acid.

Among these, trimethylolpropane tri(meth)acrylate, pentaerythritol tetra(meth)acrylate, dipentaerythritol hexa(meth)acrylate, and dipentaerythritol penta(meth)acrylate are preferred.

(2) Acrylic resins having weight-average molecular weight of 10,000 or less

As the acrylic resins having a weight-average molecular weight of 10,000 or less in the present invention, it is possible to use homopolymers and copolymers such as methacrylic acid esters such as methyl methacrylate, ethyl methacrylate, butyl methacrylate, and hydroxyethyl methacrylate, acrylic acid esters and acrylic acid such as methyl acrylate, ethyl acrylate, butyl acrylate, and α-ethylhexyl acrylate, maleic acid and maleic acid esters, maleic anhydrides, itaconic acid, crotonic acid, styrene such as styrene, vinyl toluene, a-methylstyrene, 2-methyl styrene, chlorostyrene, vinyl benzoate, sodium vinylbenzene sulfonate, and aminostyrene and derivatives thereof, and copolymers containing at least (meth)acrylic acid and benzyl (meth)acrylate are preferably used.

The weight-average molecular weight is preferably 10,000 or less, more preferably 2,500 to 9,000, and particularly preferably 5,000 to 8,000 since the acrylic resins are used as the plasticizer.

(3) Butyral Resins

As the butyral resins, resins having a degree of butylation of 70% or higher are preferred. When the degree of butylation is low, the thermal adhesiveness deteriorates. In addition, the degree of polymerization is preferably 300 or higher, more preferably 600 or higher, and particularly preferably 1,000 or higher. When the degree of polymerization is low, it becomes difficult to adjust the surface roughness using the Benard cells method.

In association with the selection of the butyral resins, a polymer hydrophobization technique is preferably introduced in order to lessen the water-absorbing property. Examples of the polymer hydrophobization technique include a reaction of a hydroxyl group with a hydrophobic group, crosslinking of two or more hydroxyl groups using a hardener, or the like as described in JP1996-238858A (JP-H08-238858A).

Specific examples of the butyral resins will be described below, but the butyral resins are not limited thereto.

“DENKA BUTYRAL (registered trademark) #2000-L” manufactured by Denka Company Limited, Vicat softening point: 57° C.

“S-LEC (registered trademark) FPD-1” manufactured by Sekisui Chemical Co., Ltd., softening point: 70° C.

“S-LEC (registered trademark) B BL-S” manufactured by Sekisui Chemical Co., Ltd., softening point: 110° C.

“S-LEC (registered trademark) B BL-SH” manufactured by Sekisui Chemical Co., Ltd., softening point: 116° C.

(4) Rosin Resins

Examples of the rosin resins include rosin, hydrogenated rosin, modified rosin, derivatives thereof (esterified products), rosin-modified maleic acid resins, and the like. As rosin acid constituting the rosin resins, it is possible to use any of abietic acid-type rosin acid or pimaric acid-type rosin acid. Among these, rosin containing 30% by mass or more of abietic acid-type rosin acid and esterified products between rosin and at least one polyvalent alcohol selected from ethylene glycol, glycerol, and pentaerythritol are preferred. Specific examples of the abietic acid-type rosin acid include abietic acid, neoabietic acid, palustric acid, dihydroabietic acid, dehydroabietic acid, and the like.

Specific examples of the rosin resins will be described below, but the rosin resins are not limited thereto.

“KR612”, manufactured by Arakawa Chemical Industries, Ltd., Vicat softening point: 80° C. to 90° C.

“KE311”, manufactured by Arakawa Chemical Industries, Ltd., Vicat softening point: 90° C. to 100° C.

“KE604”, manufactured by Arakawa Chemical Industries, Ltd., Vicat softening point: 124° C. to 134° C.

“KR140”, manufactured by Arakawa Chemical Industries, Ltd., Vicat softening point: 130° C. to 150° C.

(5) Wax

Examples of wax compounds include mineral-based wax, natural wax, synthetic wax, and the like. Examples of the mineral-based wax include petroleum wax such as paraffin wax, microcrystalline wax, ester wax, and oxidized wax, montan wax, ozokerite, ceresin, and the like. Among these, paraffin wax is preferred. Paraffin wax is wax separated from petroleum, and a variety of types of paraffin wax having different melting points are commercially available. Examples of the natural wax include plant wax such as carnauba wax, tree wax, auricuri wax, and espal wax and animal wax such as beeswax, insect wax, shellac wax, and whale wax.

Synthetic wax is generally used as a lubricant and is ordinarily made of a higher aliphatic compound. Examples of the synthetic wax include the following wax.

1) Fatty Acid-Based Wax:

Linear saturated fatty acids represented by

General Formula: CH₃(CH₂)ₙCOOH

(In the above-described formula, n represents an integer of 6 to 28.).

Specific examples thereof include stearic acid, behenic acid, palmitic acid, 12-hydroxystearic acid, azelaic acid, and the like. In addition, examples thereof include metal salts (for example, K, Ca, Zn, Mg, and the like) of the above-described fatty acids and the like.

2) Fatty Acid Ester-Based Wax:

Specific examples of the fatty acid esters include ethyl stearate, lauryl stearate, ethyl behenate, hexyl behenate, behenyl myristate, and the like.

3) Fatty Acid Amide-Based Wax:

In a case in which a fatty acid amide is used, a combination of a fatty acid amide of a saturated fatty acid and a fatty acid amide of an unsaturated fatty acid is more preferably used as the fatty acid portion. Specific examples of an amide of a saturated fatty acid as the fatty acid portion include stearic acid amide, lauric acid amide, palmitic acid amide, behenic acid amide, myristic acid amide, and the like. Specific examples of an amide of an unsaturated fatty acid as the fatty acid portion include oleic acid amide, erucic acid amide, and the like. Examples of additional fatty acid amides include substituted amides such as bisamide and methylolamide.

4) Aliphatic Alcohol-Based Wax

Linear saturated aliphatic alcohols represented by

General Formula: CH₃(CH₂)ₙOH

(In the above-described formula, n represents an integer of 6 to 28.).

Specific examples thereof include steary alcohols.

Among the synthetic wax of 1) to 4), the fatty acid amide is preferred, and, particularly, higher fatty acid amides such as stearic acid amide and lauric acid amide are preferred.

Additionally, the plasticizer being used is preferably an ester compound, and examples thereof include well-known plasticizers such as phthalic acid esters such as dibutyl phthalate, di-n-octyl phthalate, di(2-ethylhexyl) phthalate, dinonyl phthalate, dilauryl phthalate, butyl lauryl phthalate, and butyl benzyl phthalate, aliphatic dibasic acid esters such as di(2-ethylhexyl) adipate and di(2-ethylhexyl) sebacate, phosphate triesters such as tricresyl phosphate and tri(2-ethylhexyl) phosphate, polyol polyesters such as polyethylene glycol ester, and epoxy compounds such as epoxy fatty acid esters.

In addition, the plasticizer may be a high molecule, and, among high molecules, polyester is preferred since the addition effect is huge and polyester does not easily diffuse under storage conditions. Examples of the polyester include sebacic acid-based polyester, adipic acid-based polyester, and the like. Furthermore, additives that are added to the image-forming layer are not limited to the above-described substances. In addition, the plasticizer may be used singly or two or more plasticizers may be jointly used.

The content of the plasticizer is preferably 5 parts by mass or more and 50 parts by mass or less with respect to 100 parts by mass of the total solid content of the image-forming layer. When the content thereof is in the above-described range, the viscosity of the image-forming layer while being melted due to heat generated from the photothermal conversion layer is optimized, the adhesiveness of the image-forming layer to transfer subjects improves, and the resolution of images improves.

“Others”

The image-forming layer may further include, in addition to the above-described components, a surfactant, inorganic or organic fine particles (metal powder, silica gel, and the like), oils (flaxseed oil, medicinal oil, and the like), a viscosity improver, an antistatic agent, and the like. Except when black images are obtained, the inclusion of a substance that absorbs the wavelength of a light source used for image recording enables energy necessary for transferring to decrease. The substance that absorbs the wavelength of the light source may be any of a pigment or a dye; however, in a case in which color images are obtained, it is preferable to use an infrared light source such as a semiconductor laser for image recording and use a dye which slightly absorbs the visible light portion and significantly absorbs the wavelength of the light source from the viewpoint of color reproduction. Examples of the near-infrared dye include the compounds described in JP1991-103476A (JP-H03-103476A).

[Solvent]

The image-forming layer can be provided by preparing a coating fluid obtained by dissolving or dispersing the pigments, the binder, and the like in a solvent and applying and drying this coating fluid on the photothermal conversion layer (a heat-sensitive peeling layer described below in a case in which the heat-sensitive peeling layer is provided on the photothermal conversion layer). Examples of the solvent used to prepare the coating fluid include n-propyl alcohol, methyl ethyl ketone, propylene glycol monomethyl ether, propylene glycol monmethyl ether acetate, methanol, water, and the like. The coating and the drying can be carried out using an ordinary coating method and an ordinary drying method.

The thickness of the image-forming layer is preferably 0.2 μm or more and 1.2 μm or less since even transferred images are easily obtained.

(Cushion Layer)

A cushion layer having a cushioning function is preferably provided between the support and the photothermal conversion layer, particularly, in a case in which the color filter is formed. When the cushion layer is provided, the adhesiveness between the image-forming layer and a transfer subject during laser heat transferring improves, and the quality of images can be improved. In addition, even when foreign substances enter between the image-forming material and an image-receiving sheet during recording, due to the deformation action of the cushion layer, the gap between an image-receiving layer and the image-forming layer becomes small, and consequently, the size of image defects such as voids can also be decreased.

The cushion layer has a constitution that is easily deformed when stress is applied to interfaces and is preferably made of a material having a low elastic modulus, a material as elastic as rubber, or a thermoplastic resin that easily softens due to heating. The elastic modulus of the cushion layer at room temperature is preferably 0.5 MPa to 1.0 GPa, particularly preferably 1 MPa to 0.5 GPa, and more preferably 10 to 100 MPa. In addition, in order to sink foreign substances such as trash, the penetration (25° C., 100 g, 5 seconds) specified by JIS K2530 is preferably 10 or higher. In addition, the glass transition temperature (Tg) of the cushion layer is 80° C. or lower and preferably 25° C. or lower, and the softening point is preferably 50° C. to 200° C. It is also possible to preferably carry out the addition of the plasticizer to the binder in order to adjust these properties, for example, Tg.

Specific examples used as the binder in the cushion layer include rubber such as urethane rubber, butadiene rubber, nitrile rubber, acrylic rubber, and natural rubber, furthermore, polyethylene, polypropylene, polyester, styrene-butadiene copolymers, ethylene-vinyl acetate copolymers, ethylene-acrylic copolymers, vinyl chloride-vinyl acetate copolymers, vinylidene chloride resins, plasticizer-added vinyl chloride resins, polyamide resins, phenolic resins, and the like. Furthermore, the thickness of the cushion layer is generally 3 to 100 μm and preferably 10 to 52 μm while varying depending on the resin being used and other conditions.

(Heat-Sensitive Peeling Layer)

On the photothermal conversion layer in the image-forming material, gas is generated due to the action of heat generated from the photothermal conversion layer, but it is possible to provide a heat-sensitive peeling layer including a heat-sensitive material that emits attached water or the like and thus weakens the joint strength between the photothermal conversion layer and the image-forming layer. As the above-described heat-sensitive material, it is possible to use a compound that is decomposed or modified due to heat and thus generates gas (a polymer or a low-molecular-weight compound), a compound that absorbs or adsorbs a large amount of easily-gasifying liquid such as moisture (a polymer or a low-molecular-weight compound), or the like. These heat-sensitive materials may be jointly used.

Examples of the polymer that is decomposed or modified due to heat and thus generates gas include self-oxidizing polymers such as nitrocellulose, halogen-containing polymers such as chlorinated polyolefin, chlorinated rubber, poly rubber chloride, polyvinyl chloride, and polyvinylidene chloride, acrylic polymers such as polyisobutyl (meth)acrylate to which a volatile compound such as moisture is adsorbed, cellulose esters such as ethyl cellulose to which a volatile compound such as moisture is adsorbed, natural high-molecular-weight compounds such as gelatin to which a volatile compound such as moisture is adsorbed, and the like.

Examples of the low-molecular-weight compound that is decomposed or modified due to heat and thus generates gas include compounds that are thermally decomposed and thus generate gas such as diazo compounds and azide compounds. Furthermore, the heat-sensitive material is preferably decomposed, modified, or the like due to heat at 280° C. or lower and particularly preferably decomposed, modified, or the like at 230° C. or lower.

In a case in which a low-molecular-weight compound is used as the heat-sensitive material in the heat-sensitive peeling layer, the low-molecular-weight compound is desirably combined with a binder. As the binder, it is possible to use the above-described polymer that is decomposed or modified due to heat and thus generates gas, but it is also possible to use an ordinary binder that does not have the above-described property. In case in which the heat-sensitive low-molecular-weight compound and the binder are jointly used, the mass ratio therebetween is preferably 0.02:1 or more and 3:1 or less and more preferably 0.05:1 or more and 2:1 or less.

The heat-sensitive peeling layer desirably coats almost the entire surface of the photothermal layer, and the thickness thereof is generally in a range of 0.03 μm or more and 1 μm or less and preferably in a range of 0.05 μm or more and 0.5 μm or less.

In the case of the image-forming material having a constitution in which the photothermal conversion layer, the heat-sensitive peeling layer, and the image-forming layer are laminated on the support in this order, the heat-sensitive peeling layer is decomposed and modified due to heat transferred from the photothermal conversion layer and thus generates gas. In addition, the decomposition or the generation of gas eliminates a part of the photothermal conversion layer or causes cohesion failure in the heat-sensitive peeling layer, and the bonding force between the photothermal conversion layer and the image-forming layer decreases. Therefore, depending on the behaviors of the heat-sensitive peeling layer, the eliminated part is attached to the image-forming layer, appears on the surface of the finally-formed image, and, in some cases, causes color mixing in the image. Therefore, it is desirable that the heat-sensitive peeling layer is rarely colored, that is, exhibits high transparency with respect to visible light so as to prevent visible color mixing from appearing on formed images even when the above-described transfer of the heat-sensitive peeling layer occurs.

Specifically, the light absorbance of the heat-sensitive peeling layer is 50% or lower and preferably 10% or lower with respect to visible light. Furthermore, it is also possible to provide the image-forming material with a constitution in which the heat-sensitive material is added to the photothermal conversion layer coating fluid so as to form the photothermal conversion layer and the layer is made to function as both the photothermal conversion layer and the heat-sensitive peeling layer instead of providing an independent heat-sensitive peeling layer.

The coefficient of static friction of the outermost layer of the image-forming material on a side on which the image-forming layer is provided is set to 0.35 or lower and preferably set to 0.20 or lower. When the coefficient of static friction of the outermost layer is set to 0.35 or lower, rolls are not significantly contaminated during the transportation of the image-forming material, and the quality of images being formed can be improved. The method for measuring the coefficient of static friction is based on the method described in Paragraph (0011) of JP2000-85759A.

The Smooster value of the image-forming layer surface is preferably 0.5 mmHg to 50 mmHg (that is, 0.0665 kPa to 6.65 kPa) at a temperature of 23° C. and a relative humidity of 55%, and the central line average roughness Ra is preferably 0.05 μm to 0.4 μm. The Smooster value and the central line average roughness are preferred from the viewpoint of the possibility of decreasing the number of many micropores with which neither the image-receiving layer nor the image-forming layer are capable of coming into contact in the contact surface and transferring, and furthermore, the quality of images. Ra can be measured using a surface roughness measurement instrument (Surfcom, manufactured by Tokyo Seimitsu Co., Ltd.) on the basis of JIS B0601.

The surface hardness of the image-forming layer is preferably 10 g or more in a load region measurement using a sapphire needle having a curvature radius (R) of 0.3 mmR at the needle tip in a wear resistance tester.

The charge potential of the image-forming layer is preferably −100 to 100 V one second after the image-forming material is charged according to Federal Test Standard 101C Method 4046 and then the image-forming material is earthed.

The surface electrical resistance of the image-forming layer is preferably 10⁹ Ω/sq or less at a temperature of 23° C. and a relative humidity of 55%.

(Image-Forming Method)

The reflective display device according to the present invention preferably has a color filter including pixels that are formed according to the following image-forming method using the above-described image-forming material. That is, the image-forming method includes the formation of a laminate by superimposing the above-described image-forming material on the surface of a transfer subject, the radiation of laser light to the image-forming material side of the formed laminate in an image shape, and the peeling of the image-forming material to which laser light has been radiated in an image shape from the surface of the transfer subject.

At least a part of a laser light-irradiated region in the image-forming layer is transferred to the surface of the transfer subject using the image-forming method, thereby forming an image having an image shape on the surface of the transfer subject.

The transfer subject may be electrophoresis display unit 1 in FIG. 1, and the respective pixels of the color filter are formed on the surface of the transparent substrate 17 in electrophoresis display unit 1 on a side opposite to the surface on which the transparent electrode 13 is formed.

In addition, as another method, it is also possible to select, for example, a plastic film such as polyethylene terephthalate (hereinafter, also referred to as “PET”) as a transfer subject and form the respective pixels of the color filter in the same manner as in the above-described method on the surface of the plastic film. A color filter produced by forming a color filter layer on the surface of the plastic film can be attached to the surface of electrophoresis display unit 1 through an adhesive layer.

In order to laminate the image-forming layer in the image-forming material on the surface of the transfer subject, a variety of methods can be employed. For example, the laminate can be easily obtained by superimposing the image-forming layer in the image-forming material on the surface of a desired member (electrophoresis display unit 1, the plastic film, or the like) as the transfer subject and passing the image-forming layer and the member through pressurization and heating rollers. In this case, the heating temperature is 160° C. or lower and preferably 130° C. or lower.

As another method for obtaining the laminate, a vacuum attachment method is also preferably used. The vacuum attachment method is a method in which a transfer subject is wound on a drum provided with suction holes for vacuuming and then an image-forming material that is slightly larger than the transfer subject is vacuum-attached to a sheet under suctioning and the homogeneous extraction of the air using squeeze rollers. In addition, as another method, a method in which a transfer subject is stretched on and mechanically attached to a metal drum, furthermore, an image-forming material is mechanically stretched and attached thereon in the same manner is also employed. Among these methods, the vacuum attachment method is particularly preferred since it is not necessary to control the temperature of heat rollers and the like, and it is easy to rapidly and uniformly laminate the components.

The laminate may be obtained in the same manner using a flatbed provided with a suctioning hole for vacuuming instead of the drum provided with a suctioning hole for vacuuming.

(Image-Shape Exposure)

Laser light used for light radiation in the formation of polychromic images is preferably multi-beam light and particularly preferably a multi-beam two-dimensional array. The multi-beam two-dimensional array refers to the fact that, when recording is performed by unit of laser light radiation, a plurality of laser beams are used, and the spot array of these laser beams is a two-dimensional planar arrangement made up of a plurality of columns in the main scanning direction and a plurality of rows in the sub scanning direction. When laser light which is the multi-beam two-dimensional array is used, it is possible to shorten the time necessary for laser recording.

The laser light being used can be used without any particular limitation, and gas laser light such as argon ion laser light, helium neon laser light, or helium cadmium laser light, solid laser light such as YAG laser light, or direct laser light such as semiconductor laser light, colorant laser light, or excimer laser light is used. Furthermore, it is also possible to use light obtained by converting these laser light rays to half wavelengths through a secondary harmonic element.

In the polychromic image-forming method, when the output power, ease of modulation, and the like are taken into account, semiconductor laser light is preferably used. In the polychromic image-forming method, the laser light is radiated under conditions in which the beam diameter on the photothermal conversion layer preferably falls into a range of 5 μm or more and 50 μm or less and more preferably falls into a range of 6 μm or more and 30 μm or less, and the scanning rate is preferably set to 1 m/second or more (particularly, 3 m/second or more).

(Peeling)

After the laminate is exposed in an image shape, the image-forming material is peeled off from the transfer subject. On the transfer subject, images to which a laser light-irradiated portion in the image-forming layer in the image-forming material has been transferred are formed. The color filter produced using the above-described image-forming material has pixels having excellent contrast and resolution.

### EXAMPLES

Hereinafter, the present invention will be more specifically described using examples. Materials, amounts used, proportions, processing contents, processing orders, and the like described in the following examples can be appropriately changed within the scope of the gist of the present invention. Therefore, the scope of the present invention is not limited to the examples described below. Meanwhile, unless particularly otherwise described, “parts” is mass-based.

### Example 1

A. Production of image-forming material for forming photothermal conversion layer 1. Production of photothermal conversion layer

(1) Preparation of coating fluid for forming photothermal conversion layer

Individual components described below were stirred and mixed together in a stirrer, thereby preparing a coating fluid for forming the photothermal conversion layer.

[Composition of Coating Fluid]

Infrared-absorbing colorant (NK-2014, manufactured by Japanese Res. Inst. for Photosensitizing Dyes Co., Ltd.): 10 parts

Binder (RIKACOAT SN-20F, manufactured by New Japan Chemical Co., Ltd.): 200 parts

N-methyl-2-pyrrolidone: 2,000 parts

Surfactant (MEGAFAC F-177, manufactured by DIC Corporation): 1 part

(2) Formation of photothermal conversion layer on support surface

After the coating fluid for forming a photothermal conversion layer was applied on the surface of a 100 μm-thick biaxially-stretched PET film using a rotary coater (whirler), the coated substance was dried in an oven at 100° C. for two minutes, thereby forming a photothermal conversion layer on the surface of the PET film.

The obtained photothermal conversion layer had the absorption maximum at near 830 nm in a wavelength range of 700 nm to 1,000 nm, and the absorbance (optical density: OD) thereof was measured using a Macbeth transmission reflection densitometer (manufactured by Macbeth Corporation) and was found to be 1.0. The film thickness of the photothermal conversion layer was found to be 0.3 μm on an average by observing a cross-section of the photothermal conversion layer using a scanning electron microscope.

2. Production of image-forming layer

(1) Preparation of coating fluid for forming image-forming layer 1) Preparation of red pigment-dispersed composition R-1

<Preparation of Red Color Material Composition>

Commercially available C.I. Pigment Red 254 (red pigment) (100 parts), sodium chloride (400 parts), and diethylene glycol (140 parts) as a water-soluble organic solvent were prepared in a desktop kneader (manufactured by IRIE Shokai Co., Ltd.) and were kneaded for ten hours. Next, the obtained kneaded substance was stirred and mixed with water in a dissolver (manufactured by Nissei Corporation), and then was repeatedly filtered and washed with water so as to remove sodium chloride and the solvent, thereby obtaining a water cake of the red pigment. The obtained water cake was dried in an oven at 80° C. for six hours, thereby obtaining a red color material composition.

<Rough Dispersion>

After individual components of the following composition were mixed together using the red color material composition so as to obtain a mixture, the mixture was dispersed using an Eiger mill (manufactured by Eiger Co., Ltd.) and zirconia beads having a diameter of 0.8 mm.

<Composition>

The above-described red color material composition: 100 parts

Dispersion aid (SOLSPERSE (registered trademark) 22000, manufactured by The Lubrizol Corporation): 10 parts

Dispersant (SOLSPERSE (registered trademark) 24000, manufactured by The Lubrizol Corporation): 40 parts

Propylene glycol monomethyl ether acetate: 150 parts

<Precision Dispersion>

The dispersed substance after the rough dispersion was taken out, propylene glycol monomethyl ether acetate (75 parts) was added to the dispersed substance (300 parts), and both components were mixed together. After that, the mixture was dispersed using an Eiger mill (manufactured by Eiger Co., Ltd.) and zirconia beads having a diameter of 0.1 mm.

<Temperature Adjustment>

The dispersed substance after the precision dispersion was taken out and was diluted by adding propylene glycol monomethyl ether acetate thereto so as to obtain a pigment concentration of 20% by mass, thereby producing a red pigment-dispersed composition R-1.

The number-average particle diameter of C.I. Pigment Red 254 in the red pigment-dispersed composition R-1 was 60 nm.

2) Preparation of yellow pigment-dispersed composition Y-1

A yellow pigment-dispersed composition Y-1 was prepared in the same manner as in the preparation of the red pigment-dispersed composition R-1 except for the fact that C.I. Pigment Red 254 was changed to commercially available C.I. Pigment Yellow 138.

The number-average particle diameter of C.I. Pigment Yellow 138 in the yellow pigment-dispersed composition Y-1 was 70 nm.

3) Preparation of coating fluid for forming red image-forming layer

Next, individual components described below were stirred and mixed together using a stirrer, thereby preparing a coating fluid for forming a red image-forming layer.

Red pigment-dispersed composition R-1: 240.0 parts

Yellow pigment-dispersed composition Y-1: 60.0 parts

Binder A (a random copolymer of methacrylic acid and benzyl methacrylate in a molar ratio of 28/72, a weight-average molecular weight of 38,000): 15.0 parts

Plasticizer (dipentaerythritol hexamethacrylate, manufactured by Nippon Kayaku Co., Ltd.): 24.9 parts

Surfactant (MEGAFAC (registered trademark) F-780F, manufactured by DIC Corporation): 0.1 parts

Propylene glycol monomethyl ether acetate: 660.0 parts

(2) Formation of red image-forming layer on photothermal conversion layer surface

After the coating fluid for forming a red image-forming layer was applied on the surface of the photothermal conversion layer, the coated substance was dried in an oven at 120° C. for two minutes, thereby forming a red image-forming layer on the photothermal conversion layer.

The absorbance (optical density: OD) of the obtained red image-forming layer was measured using a Macbeth transmission reflection densitometer TD504(B) manufactured by Macbeth Corporation and was found to be 1.2. The film thickness of the red image-forming layer was found to be 0.9 μm on an average.

By means of the above-described steps, an image-forming material for forming red images provided with the photothermal conversion layer and the red image-forming layer in this order on a support was produced.

3. Formation of Transferred Image

The 100 μm-thick biaxially-stretched PET film (25 cm×35 cm) was wound on a rotary drum having a diameter of 25 cm which was provided with suction holes for vacuuming (at a surface density of one hole per 3 cm×3 cm area) having a diameter of 1 mm and then the film was adsorbed to the rotary drum. Next, the 30 cm×40 cm image-forming material for forming red images was superimposed on the film under continuous vacuuming so that the red image-forming layer comes into contact with the surface of the biaxially-stretched PET film and evenly protrudes from the outer circumference of the PET film, and the image-forming material for forming red images and the biaxially-stretched PET film are attached and laminated together by squeezing the image-forming material and the film using squeeze rollers and absorbing the air into the suction holes. The degree of pressure reduction in a state in which the suction holes were blocked was −150 mmHg (that is, 81.13 kPa) with respect to 1 atmosphere.

Next, the drum was rotated, semiconductor laser light having a wavelength of 830 nm was collected on the surface of the laminate on the drum from the outside so that 7 μm spots were formed on the surface of the photothermal conversion layer, and laser image recording was carried out on the laminate while moving the semiconductor laser light in a direction perpendicular to the rotary direction (the main scanning direction) of the rotary drum (sub scanning).

The laser light radiation conditions are as described below.

Laser power: 110 mW

Main scanning rate: 4 m/second

Sub scanning pitch (the amount of sub scanning per rotation): 6.35 μm

Temperature and humidity: 25° C., 50% RH

The laminate on which the laser image recording had been carried out was removed from the drum, and the image-forming material for forming red images was pulled off from the surface of the biaxially-stretched PET film, and consequently, it was confirmed that only the laser light-irradiated portions in the red image-forming layer were transferred to the surface of the biaxially-stretched PET film.

B. Production of Image-Forming Material for Forming Green Images

1. A coating fluid for forming green image-forming layers having the following composition was prepared using a green pigment-dispersed composition G-1 prepared in the following manner and the yellow pigment-dispersed composition Y-1 prepared in Example 1. An image-forming material for forming green images was produced in the same manner as in the preparation of the image-forming material for forming red images except for the fact that the prepared coating fluid for forming a green image-forming layer was used instead of the coating fluid for forming the red image-forming layer.

[Method for Preparing Green Pigment-Dispersed Composition G-1]

<Preparation of Color Material Composition>

Commercially available C.I. Pigment Green 36 (100 parts), sodium chloride (400 parts), and diethylene glycol (140 parts) as a water-soluble organic solvent were prepared in a desktop kneader (manufactured by IRIE Shokai Co., Ltd.) and were kneaded for ten hours. Next, the obtained kneaded substance was stirred and mixed with water in a dissolver (manufactured by Nissei Corporation), and then was repeatedly filtered and washed with water so as to remove sodium chloride and the solvent, thereby obtaining a water cake of the red pigment. The obtained water cake was dried in an oven at 80° C. for six hours, thereby obtaining a red color material composition.

<Rough Dispersion>

A mixture prepared in the following composition using the green color material composition was dispersed using an Eiger mill (manufactured by Eiger Co., Ltd.) and zirconia beads having a diameter of 0.8 mm.

Green color material composition: 100 parts

Dispersion aid (SOLSPERSE (registered trademark) 5000, manufactured by The Lubrizol Corporation): 10 parts

Dispersant (SOLSPERSE (registered trademark) 24000, manufactured by The Lubrizol Corporation): 40 parts

Propylene glycol monomethyl ether acetate: 150 parts

<Precision Dispersion>

The dispersed substance after the rough dispersion was taken out, propylene glycol monomethyl ether acetate (75 parts) was added to the dispersed substance (300 parts), and both components were mixed together. After that, the mixture was dispersed using an Eiger mill (manufactured by Eiger Co., Ltd.) and zirconia beads having a diameter of 0.1 mm.

<Temperature Adjustment>

The dispersed substance after the precision dispersion was taken out and was diluted by adding propylene glycol monomethyl ether acetate thereto so as to obtain a pigment concentration of 20% by mass, thereby producing a green pigment-dispersed composition G-1. The number-average particle diameter of C.I. Pigment Green 36 in the green pigment-dispersed composition G-1 was 60 nm.

[Preparation of Coating Fluid for Forming Green Image-Forming Layer]

Individual components described below were stirred and mixed together using a stirrer, thereby preparing a coating fluid for forming a green image-forming layer.

Green pigment-dispersed composition R-1: 240.0 parts

Yellow pigment-dispersed composition Y-1: 60.0 parts

Binder A (a random copolymer of methacrylic acid and benzyl methacrylate in a molar ratio of 28/72, a weight-average molecular weight of 38,000): 15.0 parts

Plasticizer (dipentaerythritol hexamethacrylate, manufactured by Nippon Kayaku Co., Ltd.): 24.9 parts

Surfactant (MEGAFAC (registered trademark) F-780F, manufactured by DIC Corporation): 0.1 parts

Propylene glycol monomethyl ether acetate: 660.0 parts

C. Production of image-forming material for forming blue images

A coating fluid for forming a blue image-forming layer was prepared in the following manner using a blue pigment composition B-1 (the average particle diameter of C.I. Pigment Blue 15:6: 75 nm and the average particle diameter of C.I. Pigment Violet 23: 80 nm) for which C.I. Pigment Red 254 (red pigment) (100 parts) in the red color material composition was changed to C.I. Pigment Blue 15:6 (95 parts) and C.I. Pigment Violet 23 (5 parts).

[Preparation of Coating Fluid for Forming Blue Image-Forming Layer]

Individual components described below were stirred and mixed together using a stirrer, thereby preparing a coating fluid for forming a blue image-forming layer.

Blue pigment-dispersed composition B-1: 30.0 parts

Binder A (a random copolymer of methacrylic acid and benzyl methacrylate in a molar ratio of 28/72, a weight-average molecular weight of 38,000): 30.0 parts

Plasticizer (dipentaerythritol hexamethacrylate, manufactured by Nippon Kayaku Co., Ltd.): 24.9 parts

Surfactant (MEGAFAC (registered trademark) F-780F, manufactured by DIC Corporation): 0.1 parts

Propylene glycol monomethyl ether acetate: 66.0 parts

[Production of Color Filter]

Color filters including pixels of one of red color, green color, and blue color were produced on a 100 μm-thick biaxially-stretched PET base by repeating the same order as that in “the above-described formation of transferred images” three times using the respective image-forming materials for forming images of red (R), green (G), and red (B) which had been produced in the above-described manner.

The respective pixels were provided with a 75 μm×75 μm rectangle shape.

As electrophoresis display unit according to the present invention, a commercially available microcapsule-type monochromic electronic paper (Kindle Paper White (registered trademark) manufactured by Amazon.com, Inc. in 2014) was used after the frame thereof had been removed. The produced color filter was attached to the surface of the image display screen in the electronic paper from which the frame had been removed so that the color filter layer came into contact with the surface.

The chromaticity was measured using a spectrophotometer CM-3600d (manufactured by Konica Minolta Inc.) in a state in which the electronic paper displayed white by turning on the front light in the electronic paper. The measurement results are shown in Table 1.

Numerical values shown in Table 1 correspond to the states of pure red, pure green, and pure blue reflected light rays into which the color filter was combined except for the fact that the luminance reaches approximately ⅓ in actual display elements. On the basis of the data in Table 1, the color reproduction ranges (NTSC ratio) of the reflective electronic paper were computed, and the results are shown in Table 1.

TABLE 1

| | | X | Y | Z | x | y |
|---|---|---|---|---|---|---|
| Pixel | B | 5.2 | 3.7 | 18.2 | 0.192 | 0.138 |
| | G | 5.4 | 7.7 | 4.9 | 0.299 | 0.428 |
| | R | 5.0 | 3.7 | 4.5 | 0.380 | 0.282 |

| | |
|---|---|
| NTSC ratio | 12.3 |

Furthermore, the spectra (respectively TR(λ), TG(λ), and TB(λ)) of the respective pixels of R, and B in the produced color filters were measured using a spectrophotometer CM-3600d (manufactured by Konica Minolta Inc.), furthermore, the spectrum (RW(λ)) of white displayed by turning on the front light in a commercially available monochromic electronic paper (in a state in which the color filter was not placed) was measured using a spectrophotometer CM-3600d (manufactured by Konica Minolta Inc.), and the reflection spectra of the color filter were computed using the following computation equations, and it was found that RW(λ) almost matched the actual measurement value of the spectrum in a state in which the color filter was placed on the electronic paper.

[Computation Equations]

RR (λ)=2TR(λ)·RW(λ)

RG (λ)=2TG(λ)·RW(λ)

RB (λ)=2TB(λ)·RW(λ)

In the above-described computation equations, RR (λ), RG (λ), and RB (λ) each represent the reflection spectra of R, and B.

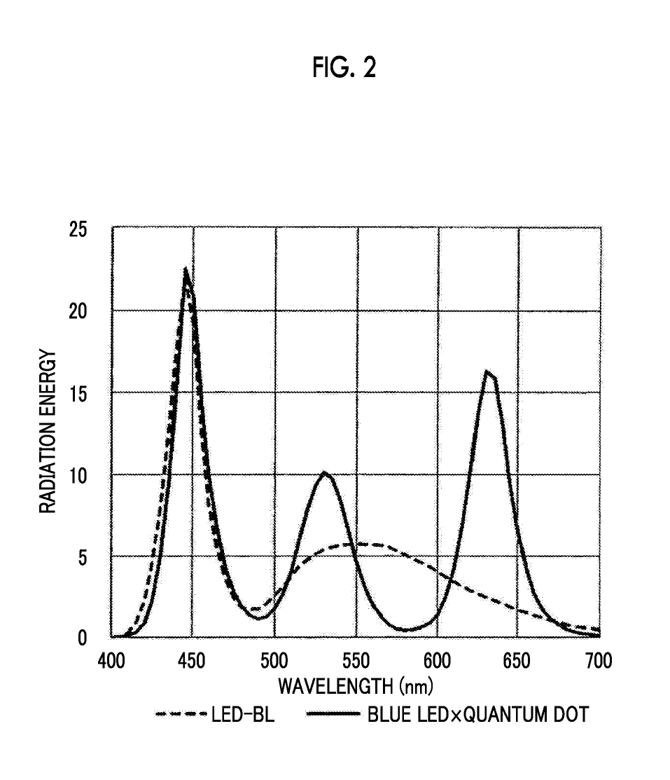

Next, a commercially available liquid crystal display device (trade name: KDL46W900A manufactured by SONY Corporation) was disassembled, the backlight unit (a unit formed by combining a blue LED and Color IQ manufactured by QD Vision, Inc.) was removed, and the spectrum (QRW(λ)) was measured using a spectrophotometer CM-3600d (manufactured by Konica Minolta Inc.). The measured spectra are illustrated in FIG. 2. In FIG. 2, the horizontal axis indicates wavelengths (unit: nm), and the vertical axis indicates radiation energy.

The reflection spectra of the color filter were obtained using the following computation equations from the measured spectra of the R pixel, the G pixel, and the B pixel and the spectrum of (blue LED+Color IQ). The results are shown in Table 2.

[Computation Equations]

RR (λ)=2TR(λ)·QRW(λ)

RG (λ)=2TG(λ)·QRW(λ)

RB (λ)=2TB(λ)·QRW(λ)

In the above-described computation equations, RR (λ), RG (λ), and RB (λ) each represent the reflection spectra of R, and B.

TABLE 2

| | | X | Y | Z | x | y |
|---|---|---|---|---|---|---|
| Pixel | B | 5.5 | 4.1 | 17.9 | 0.200 | 0.150 |
| | G | 4.4 | 7.1 | 4.8 | 0.268 | 0.434 |
| | R | 7.8 | 4.5 | 4.4 | 0.466 | 0.271 |

| | |
|---|---|
| NTSC ratio | 21.3 |

These numerical values correspond to the states of pure red, pure green, and pure blue reflected light rays into which the color filter was combined except for the fact that the luminance reaches approximately ⅓ in actual display elements, and, on the basis of these numerical values, the color reproduction ranges (NTSC ratio) of the reflective electronic paper were computed.

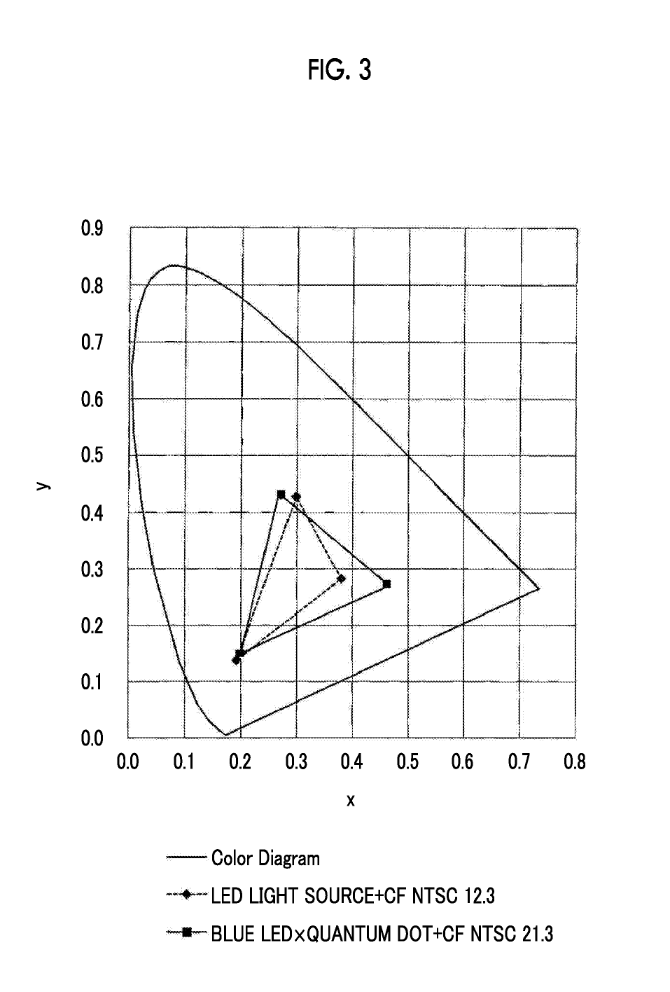

The NTSC color diagram obtained in the above-described manner is illustrated in FIG. 3.

It is found that, as illustrated in FIG. 3, the NTSC ratio is enlarged, the color reproduction ratio is significantly improved by using the front light including a light conversion member including a blue LED and quantum dots, and the visibility is excellent.

The entire content of the disclosure of JP2014-186554, filed on Sep. 12, 2014, is incorporated into the present specification by reference.

All of the publications, patent applications, and technical standards described in the present specification are incorporated into the present specification by reference to the same extent as in a case in which the incorporation of the respective publications, patent applications, and technical standards by reference is specifically and individually described.

What is claimed is:

1. A reflective display device, comprising:
electrophoresis display unit including an electrophoresis display layer; and
radiation unit which includes a primary light source that emits light in a previously-specified wavelength range and a light conversion portion including quantum dots that convert the light in a previously-specified wavelength range to white light and radiates the white light to the electrophoresis display layer from a viewer side of the electrophoresis display unit.

2. The reflective display device according to claim 1,
wherein the radiation unit includes a blue light-emitting diode that emits blue light as a primary light source, and the light conversion portion includes a quantum dot that converts blue light to red light and a quantum dot that converts blue light to green light.

3. The reflective display device according to claim 1,
wherein the radiation unit further includes a light guide plate that guides the white light converted in the light conversion portion to a viewer-side surface of the electrophoresis display layer.

4. The reflective display device according to claim 1,
wherein the electrophoresis display unit includes a pair of electrodes and a microcapsule layer disposed between the pair of electrodes, the microcapsule layer includes microcapsules including white particles, black particles, and a liquid dispersion medium, one of the white particles and the black particles have a property of being positively charged, and the other particles have a property of being negatively charged.

5. The reflective display device according to claim 1, further comprising:
a color filter layer including pixels of at least three elementary colors (red, green, and blue) between the electrophoresis display unit and the radiation unit.

6. The reflective display device according to claim 5,
wherein the color filter layer includes pixels formed using an image-forming material, the image-forming material has a photothermal conversion layer and a pixel-forming layer including a colorant and a binder on a support, and pixels are formed using laser light.

7. The reflective display device according to claim 5,
wherein the color filter layer includes pixels formed by transferring at least a part of a laser light-irradiated region of an image-forming layer in the image-forming material onto the viewer-side surface of electrophoresis display unit using an image-forming method including forming a laminate by superimposing the image-forming material having the photothermal conversion layer and the pixel-forming layer including the colorant and the binder on the support on the electrophoresis display unit, radiating laser light in an image shape from an image-forming material side of the laminate, and peeling the image-forming material in which the laser light is radiated in the image shape from the electrophoresis display unit.
